(19) United States
(12) Patent Application Publication
(10) Pub. No.: US 2019/0112049 A1
(43) Pub. Date: Apr. 18, 2019

(54) PORTABLE LAUNCH SYSTEM

(71) Applicant: Top Flight Technologies, Inc., Malden, MA (US)

(72) Inventors: Long N. Phan, Winchester, MA (US); Sanjay Emani Sarma, Lexington, MA (US); Paul A. DeBitetto, Concord, MA (US)

(21) Appl. No.: 16/162,779

(22) Filed: Oct. 17, 2018

Related U.S. Application Data
(60) Provisional application No. 62/573,197, filed on Oct. 17, 2017.

(51) Int. Cl. B64C 39/02; B64D 5/00; B64F 1/00

(52) U.S. Cl. CPC B64C 39/024; B64D 5/00; B64F 1/007; B64C 2201/206; B64C 2201/066; B64C 2201/082; B64C 2201/027

(57) ABSTRACT

An unmanned aerial vehicle includes a platform configured to transport a second unmanned aerial vehicle and release the second unmanned aerial vehicle in response to satisfying a condition. The unmanned aerial vehicle includes a hybrid generator system including an engine configured to generate mechanical power; and a generator motor coupled to the engine and configured to generate electrical power from the mechanical power generated by the engine; and at least one rotor motor configured to drive at least one propeller to rotate, wherein the at least one rotor motor is powered by the electrical power generated by the generator motor.

### CLAIM OF PRIORITY

This application claims priority under 35 U.S.C. § 119(e) to U.S. Patent Application Ser. No. 62/573,197, filed on Oct. 17, 2017, the entire contents of which are hereby incorporated by reference.

### TECHNICAL FIELD

This invention relates to a weather sensing system.

### BACKGROUND

A multi-rotor unmanned aerial vehicle (UAV) may include rotor motors, one or more propellers coupled to each rotor motor, electronic speed controllers, a flight control system (auto pilot), a remote control (RC) radio control, a frame, and a battery, such as a lithium polymer (LiPo) or similar type rechargeable battery. Multi-rotor UAVs can perform vertical take-off and landing (VTOL) and are capable of aerial controls with similar maneuverability to single rotor aerial vehicles.

### SUMMARY

In an aspect, an unmanned aerial vehicle (UAV) includes a platform configured to transport a second unmanned aerial vehicle and release the second unmanned aerial vehicle in response to satisfying a condition. The unmanned aerial vehicle includes a hybrid generator system including an engine configured to generate mechanical power; and a generator motor coupled to the engine and configured to generate electrical power from the mechanical power generated by the engine; and at least one rotor motor configured to drive at least one propeller to rotate, wherein the at least one rotor motor is powered by the electrical power generated by the generator motor.

The platform of the UAV described herein can provide one or more of the following advantages. The platform enables remote deployment of a number of additional UAVs that are able to measure environmental features of a local environment in parallel. The transportation of the number of additional UAVs to the local environment enables the additional UAVs to operate for a longer period in the local environment because the additional UAVs do not need to self-transport to and/or from the local environment.

The additional UAVs can use the platform of the first UAV as a base station for one or more operations because the platform can transport heavier equipment than the additional UAVs.

For example, the additional UAVs can use the platform as a base station for communications. The first UAV can include a more powerful communications assembly than the additional UAVs. The communications assembly is powered by a hybrid generator and can be capable of transmitting at greater power than the additional UAVs are capable of transmitting.

In another example, the additional UAVs can use the platform as a base station for power. The additional UAVs (and other remote devices of the platform) can charge and/or recharge respective power supplies of the additional UAVs from the hybrid generator of the platform. The platform can function as a configurable mobile power supply for the additional UAVs and other remote devices in the local environment, extending operating time in the local environment for the additional UAVs and other remote devices.

Embodiments can include one or more of the following features.

Satisfying the condition comprises the platform being within a predetermined distance of a specified geographic location.

Satisfying the condition comprises the platform reaching a specified altitude.

Satisfying the condition comprises the platform receiving an instruction from a remote location.

The electrical power is provided to the at least one rotor motor from the generator motor.

The unmanned aerial vehicle includes a rechargeable battery configured to store the electrical power generated by the generator motor. The electrical power is provided to the at least one rotor motor from the rechargeable battery.

The unmanned aerial vehicle includes a transceiver configured to wirelessly relay data from the second unmanned aerial vehicle to a remote location and wirelessly relay data from the remote location to the second unmanned aerial vehicle. The unmanned aerial vehicle includes a microprocessor configured to process data received from the second unmanned aerial vehicle via the transceiver and send instructions to the unmanned vehicle via the transceiver in response to an analysis of the data received in real-time or near real-time.

The platform includes a capsule for transporting the second unmanned aerial vehicle.

The platform is configured to transport one or more additional unmanned aerial vehicles and release the one or more additional unmanned aerial vehicles in response to an instruction. The one or more additional unmanned aerial vehicles and the second aerial vehicle form a mesh network.

The second unmanned aerial vehicle includes an atmospheric sensor.

The second unmanned aerial vehicle includes a beacon and a control.

The second unmanned aerial vehicle is configured to map a topology of a local environment.

In an aspect, a method for performing environmental measurements includes transporting one or more unmanned aerial vehicles using an additional unmanned aerial vehicle; and releasing, from the additional unmanned aerial vehicle, in response to satisfying a condition, the one or more unmanned aerial vehicles, wherein the one or more unmanned aerial vehicles are configured to perform environmental measurements.

Embodiments can include one or more of the following features.

The method includes relaying, by the additional unmanned aerial vehicle, data received from a remote location to the one or more unmanned aerial vehicles; and relaying, by the additional unmanned aerial vehicle, other data received from the one or more unmanned aerial vehicles to the remote location.

The method includes receiving, by the additional unmanned aerial vehicle, atmospheric measurements from the one or more unmanned aerial vehicles.

The method includes relaying, by the additional unmanned aerial vehicle, data received from a remote location outside of the local environment to the one or more unmanned aerial vehicles. In some implementations, the method includes relaying, by the additional unmanned aerial vehicle, other data received from the one or more unmanned aerial vehicles to the remote location outside of the local environment.

In some implementations, the method includes receiving, by the additional unmanned aerial vehicle, atmospheric measurements of the local environment from the one or more unmanned aerial vehicles.

In some implementations, the method includes providing, by the additional unmanned aerial vehicle, electric power to the one or more unmanned aerial vehicles to charge respective power sources of the one or more unmanned aerial vehicles after the one or more unmanned aerial vehicles have performed the environmental measurements in the local environment.

In some implementations, the method includes providing, by the additional unmanned aerial vehicle, data to the one or more unmanned aerial vehicles to enhance a navigation precision of the one or more unmanned aerial vehicles.

In some implementations, the method includes providing, by the additional unmanned aerial vehicle, a local real-time kinematic (RTK) position reference for the one or more unmanned aerial vehicles.

In some implementations, the method includes relaying, by the additional unmanned aerial vehicle global positioning system (GPS) data from a first unmanned aerial vehicle of the one or more unmanned aerial vehicles to a second unmanned aerial vehicle of the one or more unmanned aerial vehicles.

In one aspect, an unmanned aerial vehicle includes a sensor package configured to measure one or more of barometric pressure, wind speed, and wind direction. The unmanned aerial vehicle also includes a hybrid generator system that includes an engine configured to generate mechanical power, and a generator motor coupled to the engine and configured to generate electrical power from the mechanical power generated by the engine. The unmanned aerial vehicle also includes at least one rotor motor configured to drive at least one propeller to rotate. The at least one rotor motor is powered by the electrical power generated by the generator motor.

Implementations can include one or more of the following features.

In some implementations, the electrical power is provided to the at least one rotor motor from the generator motor.

In some implementations, the unmanned aerial vehicle also includes a rechargeable battery configured to store the electrical power generated by the generator motor.

In some implementations, the electrical power is provided to the at least one rotor motor from the rechargeable battery.

The details of one or more embodiments of the subject matter described herein are set forth in the accompanying drawings and the description below. Other features, objects, and advantages of the subject matter will be apparent from the description and drawings, and from the claims.

### DESCRIPTION OF DRAWINGS

FIG. 1 shows an example of the portable launch system.

FIG. 2 shows an example local environment in which a network of UAVs operates.

FIG. 3 shows an example of a UAV configured for measuring atmospheric conditions.

FIG. 4 shows an example of a sensor network that includes a plurality of UAVs.

FIG. 5 shows a diagram of an example hybrid generator system.

FIG. 6 shows a side perspective view of a hybrid generator system.

FIG. 7A shows a side view of a hybrid generator.

FIG. 7B shows an exploded side view of a hybrid generator.

FIG. 8 shows a perspective view of a hybrid generator system.

FIG. 9 shows a perspective view of a UAV integrated with a hybrid generator system.

FIG. 10 shows a graph comparing energy density of different UAV power sources.

FIG. 11 shows a graph of market potential vs. endurance for an example UAV with an example hybrid generator system.

FIG. 12 shows an example flight pattern of a UAV with a hybrid generator system.

FIG. 13 shows a diagram of a hybrid generator system with detachable subsystems.

FIG. 14A shows a diagram of a hybrid generator system with detachable subsystems integrated as part of a UAV.

FIG. 14B shows a diagram of a hybrid generator system with detachable subsystems integrated as part of a ground robot.

FIG. 15 shows a ground robot with a detachable flying pack in operation.

FIG. 16 shows a control system of a hybrid generator system.

FIGS. 17-19 show diagrams of a UAV.

FIGS. 20 and 21 show diagrams of portions of a hybrid generator system.

FIGS. 22A and 22B show diagrams of portions of a hybrid generator system.

FIG. 23 shows a diagram of a portion of an engine.

FIG. 24 shows a process of deploying UAVs with a portable launch platform.

### DETAILED DESCRIPTION

Described herein is a portable launch system for deploying one or more unmanned aerial vehicles (UAVs). The portable launch system includes one or more mini-UAVs (hereinafter “the UAVs”) and a portable launch platform, which itself is a UAV. The portable launch platform is configured to transport the UAVs from a base station at a remote location to a local environment and deploy the UAVs for collection of data characterizing the local environment, such as environmental data. In some implementations, the portable launch system analyzes the data and performs one or more actions based on the analysis, as described in more detail below. In some implementations, the UAVs are micro UAVs, such as electric drones or drones powered by a hybrid energy generation system (described in detail below). The UAVs are equipped with sensors for collecting data about the local environment. The UAVs are configured to collect environmental data of the local environment once deployed form the portable launch platform. For example, the UAVs can be weather probes.

The UAVs are mounted on the portable launch platform for transport from the base station to the local environment. The portable launch platform includes a coupling mechanism for mounting each of the UAVs onto the portable launch platform. In some implementations, the portable launch platform protects the UAVs from environmental hazards during transport to the local environment. When desired launch condition is satisfied, the portable launch platform releases the UAVs. For instance, the launch condition can be when the portable launch platform arrives at a specific location, when an instruction is received, when a particular environmental condition is detected, or another condition.

In some examples, the portable launch platform can provide a wireless communication network through which the UAVs can communicate with each other and/or with the portable launch platform. In some examples, the UAVs and the portable launch platform form a local network (e.g., a wireless network such as a mesh network). The portable launch platform performs telemetry functionality by receiving collected data from the UAVs, which act as telemeters.

In some implementations, the portable launch platform is a central control system for the UAVs. The portable launch platform can be configured to perform remote data processing functions for the UAVs in the local network. The portable launch platform can be configured to process swarm intelligence to orchestrate swarm behaviors of the UAVs. For example, when a swarm of UAVs has been deployed, the portable launch platform can be configured to control positions of UAVs in the swarm to obtain a desired sensor coverage of the local environment, such as coverage of a large area or a substantially uniform distribution of the UAVs across an area. The portable launch platform can be configured to process data indicative of the operation of the UAVs in real-time and respond to anomalies or patterns in the data. For example, if a UAV fails, the portable launch platform coordinates the swarm coverage accordingly by sending commands to the remaining UAVs to adjust their respective positions.

In some implementations, the portable launch platform acts as a network gateway between another location (e.g., the remote location of the base station) and the UAVs. For example, the portable launch platform provides relay functionality between the UAVs at the local environment and the remote location. For example, the portable launch platform receives commands transmitted from the remote location and transmits the commands to some or all of the UAVs as appropriate.

In some implementations, the portable launch system is deployed for measuring weather data at the local environment. Each UAV includes one or more sensors for measuring the weather data. In some implementations, a UAV includes sensors for measuring atmospheric conditions or other weather conditions, such as one or more of temperature, barometric pressure, humidity, wind speed, wind direction, precipitation amounts, solar radiation, visibility, cloud ceiling, moisture content (e.g., for impurities, etc.), and air content (e.g., for particulates, etc.), among others. The UAVs can all be outfitted with the same sensor(s) or each UAV or subset of the UAVs can be outfitted with different sensor(s). The measurements taken by the UAV can be used for weather forecasts, to study weather, to study climate, etc. The portable launch system can deploy UAVs at predetermined positions relative to one another such that a sensor coverage by the UAVs of a geographic enables accurate measurements of the weather and weather patterns.

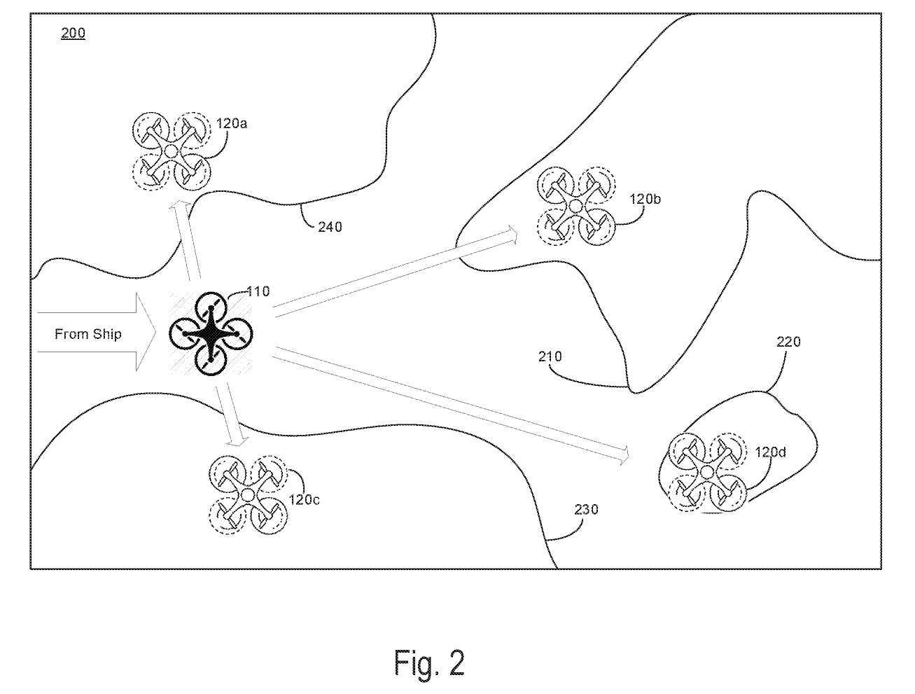

In some implementations, the portable launch system performs mapping functions at the local environment. The UAVs are equipped with sensors for measuring or identifying features of the local environment. For example, the portable launch system can be configured to generate a topological map of the local environment. The portable launch system can identify features of interest in the environment or changes to a known feature of the environment. For example, the portable launch system might be deployed to monitor changes in water depth of a water feature. The portable launch system can monitor topological changes in the local environment, such as soil erosion, landslides, etc. that may have occurred since a prior measurement. For example, the portable launch system can detect cracks in an ice shelf, glacier migration, or changes in iceberg positions or ice floes in a local environment. For example, the portable launch system may map geological phenomena, such as lava flows, rockslides, and so forth. For example, the portable launch system can monitor forest fires. Other such examples of environmental mapping and monitoring are possible. The mapping functions are described in detail in relation to FIG. 2.

In some implementations, the portable launch system can perform search and rescue operations. For example, the portable launch system can be deployed near a last known location of a missing person. The UAVs can be equipped with transmitters that can be used as beacons to assist search and rescue operations.

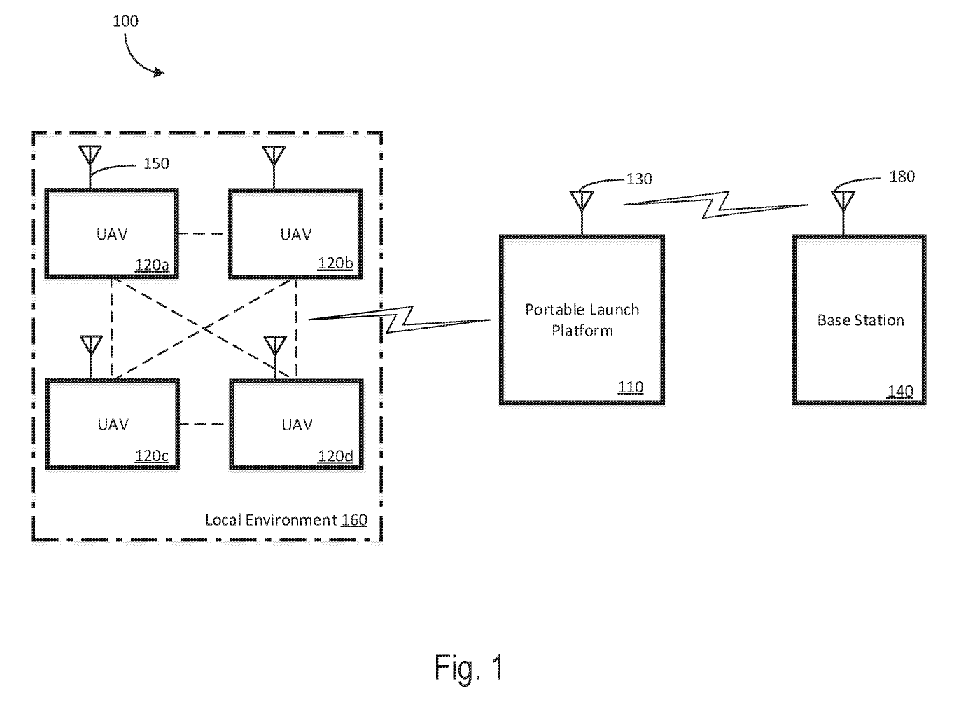

FIG. 1 shows an example of the portable launch system 100. The portable launch system 100 includes a portable launch platform 110. The portable launch platform 110 is configured to transport UAVs 120a-d, (collectively referred to as “the UAVs 120”). Though four UAVs 120 are shown, the portable launch system 100 can include other numbers of UAVs, such as a single UAV or multiple UAVs, such as dozens of UAVs. The portable launch platform 110 includes a communications device 130. The communications device 130 is configured to communicate with the UAVs 120. In some implementations, the communications device 130 is configured to communicate with a base station 140. In some implementations, one or more of the UAVs 120 has a communications device, such as communications device 150. The communications devices 130, 150 include a transmitter and a receiver, and can operate using any of a number of communication protocols.

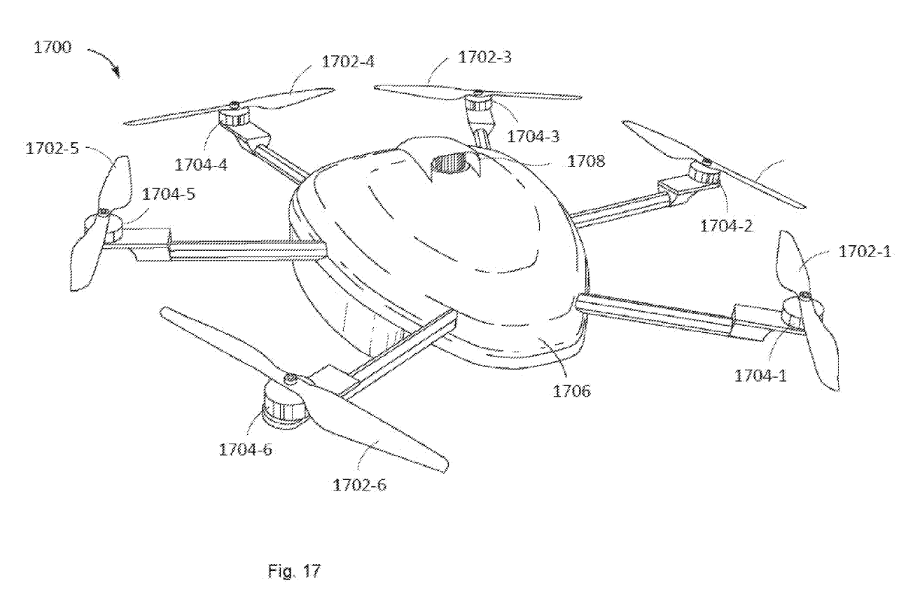

The UAVs 120 are transported from an initial location, such as the base station 140, by the portable launch platform 110, and deployed from the portable launch platform 100 into a local environment 160. In some examples, the portable launch platform 110 includes an unmanned aerial vehicle. Example implementations of the portable launch platform 110 are described below, such as in relation to FIGS. 17-19. The UAVs are affixed or otherwise coupled to the portable launch platform 110 for transport. When a launch condition is satisfied, the UAVs are released from the portable launch platform 110. For example, the portable launch platform 110 can release the UAVs 120 autonomously in response to an environmental condition detected by the portable launch platform. For example, the portable launch platform 110 can detect conditions such as proximity to a geographical coordinate, an elapsed mission time, a received signal from a target, an altitude, distance traveled, and so forth. In some implementations, the portable launch platform 110 releases the UAVs 120 in response to a command from the base station 140.

In some implementations, the UAVs 120 are miniaturized and/or simplified versions of the portable launch platform 110. The UAVs 120 can be low-cost drones that are configured to remain in the local environment 160 after being deployed, rather than being retrieved by the portable launch platform 110. In some implementations, the UAVs 120 are electrically powered drones or drones powered by a hybrid energy generation system. In some implementations, the UAVs 120 each include one or more rotors for propulsion, navigation, etc.

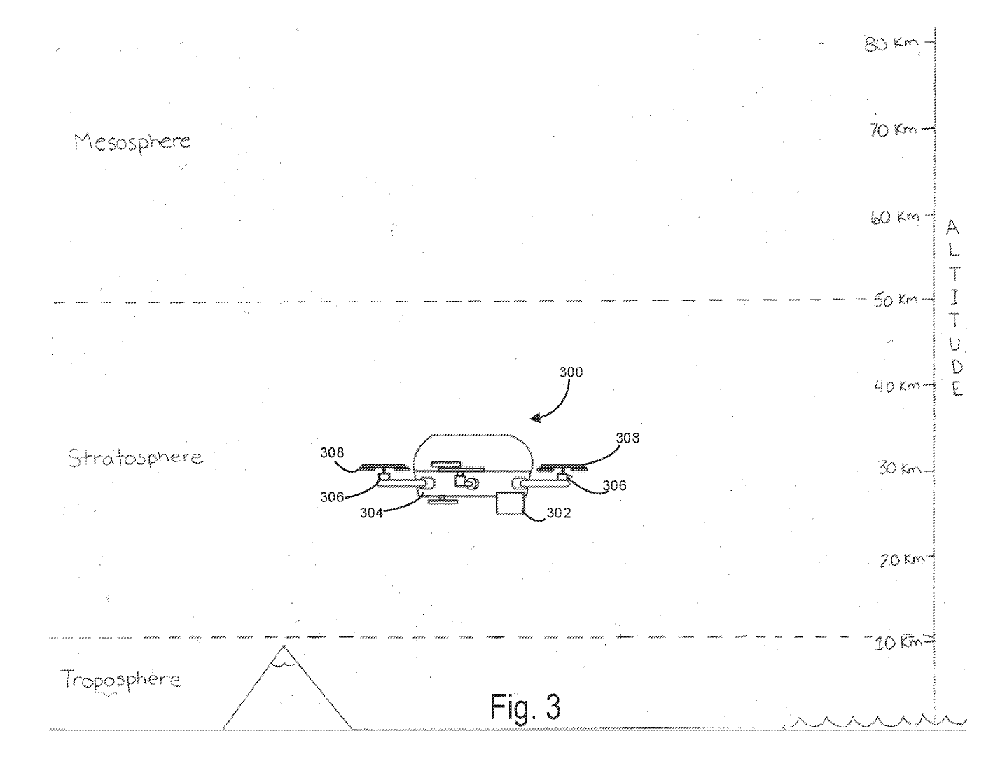

The UAVs 120 include one or more sensors, such as to perform a particular task. In some examples, the UAVs 120 can be specific to the particular task, e.g., outfitted with a specific sensor or suite of sensors. For example, the UAVs 120 can be generic UAVs configured to receive a sensor or a suite of sensors that are relevant to a mission to be performed. For example, to carry out weather monitoring, the UAVs 120 can each be equipped with a sensor package including sensors capable of measuring weather conditions, as further described in relation to FIG. 3, below. In another example, the UAVs 120 can each be equipped with a beacon (e.g., a radio transmitter, LEDs, an audio emitter, etc.) for a search and rescue operation. In yet another example, the UAVs 120 can each be equipped with a camera for performing mapping operations. Other sensors or combinations of sensors are possible, such as a compass, a global positioning system (GPS) receiver, a gyroscope, an infrared receiver, and so forth. In some implementations, the UAVs 120 each include a control, such as a button, switch, touch sensitive display, or other type of control. The control may be activated by a user to send a command to the UAV, which may depend on the function of the UAV. For example, in a search and rescue scenario, activating the control can activate a distress beacon. In another example, the control can cause a “snapshot” of the UAV's status data to be saved and/or transmitted to, e.g., the portable launch platform, another UAV, or elsewhere. Other functions of the control are possible.

In some implementations, the UAVs 120 each include the same sensors and are functionally identical to one another. For example, the UAVs 120 can form a mesh network. If a UAV is lost, the remaining UAVs can adjust to reduce the loss of coverage resulting from the loss of the UAV. In some implementations, the UAVs 120 include different combinations of sensors from one another, such as to each have a specialized function.

The portable launch platform 110 is deployed from a remote location, such as base station 140, to the local environment 160. The portable launch platform 110 transports the UAVs 120 to the local environment 160 from the remote environment. When the portable launch platform 110 has reached the local environment 160, received a command, or some other condition is satisfied, the UAVs 120 are deployed. The UAVs 120 are released from the portable launch platform 110 and can independently navigate the local environment 160, such as for data acquisition. In some examples, the portable launch platform 110 can serve as a differential global positioning system (DGPS) reference station providing corrections that enhance the navigation capability of the UAVs 120. The portable launch platform 110 can hover in place, land, return to the base station 140, receive or transmit data, or perform some other action. The UAVs 120 collect data from the local environment 160. The UAVs 120 can maneuver independently from one another and from the portable launch platform 110. The UAVs 120 each have a communication device (such as communication device 150). The UAVs can each transmit data to the portable launch platform 110 using their respective communication devices. In some implementations, the UAVs 120 transmit data to one another to coordinate one or more actions of the UAVs.

The base station 140 includes any location or object from which the portable launch platform 110 is deployed. The base station 140 includes a communication device 180, such as a transceiver, for communication with the portable launch platform 110. In some implementations, the communications device 180 of the base station communicates directly with the UAVs 120. The base station 140 can be stationary, such as a building. The base station 140 can be mobile, such as a land vehicle or a ship. For example, a freighter can deploy the portable launch platform 110 to scout local environmental conditions ahead of a navigational path of the freighter, such ice shelf conditions, atmospheric patterns, or other weather conditions, ice floe positions, and the like.

The local environment 160 includes an area of interest in which the UAVs 120 operate. The geographical size of the local environment 160 can depend on an objective of the mission. For example, for a mission that involves the UAVs 120 photographing or otherwise surveying the local environment 160, the local environment 160 might be a relatively large area, hundreds or thousands of square meters. In comparison, for a mission that involves monitoring atmospheric changes over time, the local environment 160 can be a relatively smaller area, such a few dozen meters square. The geographical size of the local environment 160 can be defined by an operational range of the UAVs 120. The operational range of the UAVs 120 can be larger for some missions than for other missions. For example, in situations where the UAVs 120 carry heavy loads (e.g., additional sensors or other supplies), the UAVs 120 have shorter flight times, and thus shorter operational ranges.

In some implementations, the portable launch platform 110 can carry a means to extend the flight times of the UAVs, such as a recharging dock. Such a means enables the UAVs 120 to divide a local environment into pieces, such as for performing a survey, and enable the UAVs to have larger operational ranges. In some implementations, maximum flight times of the UAVs 120 can be at least 30 minutes, at least 45 minutes, at least 60 minutes, at least 90 minutes, or at least 2 hours.

The recharging dock of the portable launch platform 110 can include the hybrid generator, described in further detail below. The recharging dock is configured to supply power at one or more voltages (e.g., 5V, 12V, 120V, etc.) to the UAVs 120 and/or other remote devices in the local environment. The recharging dock can be configured to supply power at different frequencies (e.g., for AC power). In some implementations, a control system of the portable launch platform 110 can determine what power type is required for a remote device that is requesting power from the portable launch platform 110. For example, a UAV 120 can request power at a particular voltage and the controller of the portable launch platform can provide the requested power output at a particular power port with which the UAV interfaces. The portable launch platform 110 thus functions as a configurable mobile power supply for secondary devices, both for UAVs 120 and other remote devices.

For example, the portable launch platform 110 can include a power source for other robotic devices that it deploys, such as ground robots the portable launch platform may drop off at various locations. Additionally, the portable launch platform is configured to recharge the remote devices for cycled use. For example, a remote device is deployed at a location by the portable launch platform 110, and the remote device performs a function in the local environment. The remote device can return to and recharge at the portable launch platform 110. The portable launch platform 110 and the remote device can communicate to coordinate this process. For example, when a power level of the remote device drops below a threshold (e.g., 10%, 20%, etc.) the portable launch platform 110 can be summoned to the location of the remote device to provide a recharging service. The portable launch platform 110 can patrol a region where one or more remote devices are deployed. The portable launch platform 110 can recharge one or more of the remote devices in sequence or in parallel as needed.

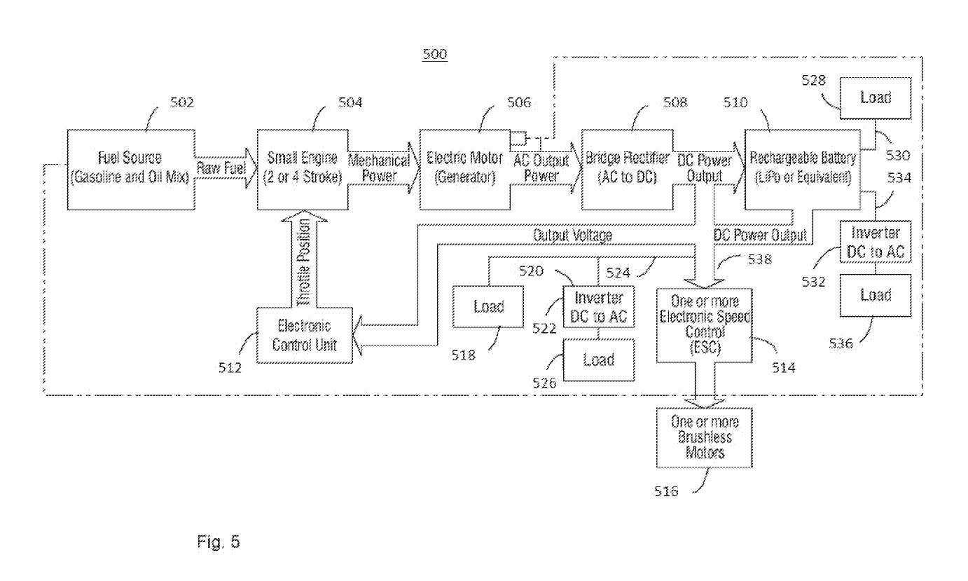

The portable launch platform 110 is configured to have a greater range of operation than the UAVs 120. For example, the portable launch platform 110 can have a greater range for transmitting data than the UAVs 120. For example, the portable launch platform 110 can have a longer maximum flight time than the UAVs 120. For example, the portable launch platform 110 can be powered by a hybrid generator system, described in more detail in relation to FIGS. 5-10, below. The UAVs 120 are smaller than the portable launch platform 110. For example, the UAVs are electrically powered and have a shorter operational period, such as a shorter flight time, than the portable launch platform 110. In some implementations, the UAVs 120 can include the hybrid generator system, described below in relation to FIGS. 5-10. For example, the UAVs 120 can include a miniaturized hybrid generator system as compared to the hybrid generator system of the portable launch platform 110.

In some implementations, the portable launch platform 110 is deployed from the home base 140 to a local environment 160 that is out of the operational range of the UAVs 120 with respect to the home base 140. The UAVs 120 can collect environmental data at local environment 160s that the UAVs cannot access directly from the home base 140. In some implementations, the portable launch platform 110 is deployed from the base station 140 to a local environment 160 that is within the operational range of the UAVs 120 with respect to the base station. The portable launch platform 110 can transport the UAVs 120 from the base station 140 to be close to a desired target of the local environment 160, extending the operational time of the UAVs at the desired target relative to an operational time for UAVs having navigated directly from the base station.

In some implementations, the portable launch platform 110 is configured to act as a relay between the UAVs 120 and the base station 140. The portable launch platform 110 can include a larger antenna or a more powerful transmitter than the UAVs 120 and thus have an extended range with respect to the transmission ranges of the UAVs 120. For example, the UAVs 120 can use low-power transmitters that are confined to transmitting in the local environment. The portable launch platform 110 can rely the data collected by the UAVs 120 to the base station 140, or store the data and physically return to the base station 140.

In some implementations, the portable launch platform 110 is configured to enhance the local navigation of the UAVs 120. For example, the potable launch platform 110 can provide a local real-time kinematic (RTK) position reference system for the UAVs 120 to enhance a precision of position data derived from satellite-based positioning systems, such as GPS. The remote launch system provides a local RTK GPS position reference for the UAVs 120 in the local environment. The UAVs 120 (and/or other remote devices) can use the position reference to run on an RTK navigation mode. The navigation of the remote devices becomes highly accurate, such as having sub-centimeter accuracy.

In some implementations, the portable launch platform 110 functions as a communications relay between the UAVs 120 (e.g., in addition to or as an alternative to being a communication relay with the base station). When the portable launch system 110 functions as a communications relay between the UAVs 120 (and/or other remote devices), the portable launch platform can compute a cooperative navigation solution for the remote devices and/or UAVs 120. The cooperative navigation solution improves an overall accuracy of some or all of the remote systems relative to each remote device navigating alone. For example, some remote devices (e.g., UAVs 120) may have an accurate GPS receiver while other UAVs 120 may be operating in a GPS-degraded or GPS-denied environment. The portable launch platform 110 shares GPS measurements between the UAVs 120 and/or remote devices. The portable launch platform 110 is also configured to share time difference of arrival (TDOA) of radio signals that are synchronized by either GPS time, or local clocks of the UAVs 120. For example, one or more the remote systems can include a chip-scale atomic clock or other such timing mechanism that maintains precise timing information.

The portable launch platform 110 can act as a remote processing unit for the UAVs 120. For example, the portable launch platform 110 can perform complex calculations to control swarm maneuvers of the UAVs 120, stitch together mapping data, find holes in coverage of the UAVs network, and the like. The UAVs 120 can thus conserve power to extend flight times in the local environment.

The UAVs 120 can each be configured to fly until each respective UAV 120 runs out of power. In some implementations, the UAVs 120 are low-cost and configured to be discarded at the local environment. For example, a UAV can determine that the UAV is about to run out of power. The UAV can notify the portable launch platform 110 that the UAV is about to crash. Once the portable launch platform 110 has received such a notification from each UAV, the portable launch platform 110 can return to the home base 140. In some implementations, the portable launch platform 110 returns to the home base 140 immediately after deploying the UAVs 120. In some implementations, the portable launch platform 110 waits at the local environment until enough data has been gathered by the UAVs 120, and then returns to the home base 140. In some implementations, the portable launch platform 110 calculates an amount of time that the portable launch platform can remain at the local environment, and returns to the home base 140 only when power constraints require the portable launch platform to return.

The UAVs 120 are affixed or otherwise coupled to the portable launch platform 110 during transport, and released at the local environment 160.

In some implementations, the UAVs 120 are affixed or otherwise coupled to the portable launch platform 110 directly. The portable launch platform 110 can include a restraining device, such as a latch, electromagnet, gate, etc. for securing the UAVs 120 during transport. To release the UAVs 120, the portable launch platform 110 sends a signal to the restraining device, such as to open the latch or depower the electromagnet. The UAVs 120 are activated prior to being released by the portable launch platform 110. In some implementations, the UAVs 120 drop away from the portable launch platform 110 to perform mission functions. In some implementations, the UAVs 120 take off from the portable launch platform 110 to perform mission functions. The portable launch platform 110 can release the UAVs 120 while airborne or after landing in the local environment 160.

In some implementations, the UAVs 120 are indirectly affixed or otherwise coupled to the portable launch platform 110. For example, the UAV 120 includes a container for holding the UAVs 120, such as a canister. To deploy the UAVs 120, the portable launch platform 110 sends a signal to open the canister. The container can be released at the local environment 160. The UAVs 120 exit the container. In some implementations, the UAVs 120 are transported in a folded geometry and are configured to unfold when deployed. Other details of a canister deployment system for UAVs can be found in application Ser. No. 15/593,803, incorporated herein in entirety by reference.

The UAVs 120 are deployed at the local environment and form a local network. FIG. 2 shows an example local environment 200 in which a network of UAVs 120 operates. In this example, the portable launch platform 110 is deployed to survey a shipping lane. The portable launch platform 110 is deployed from a ship (not shown) at a remote location. Once the local environment 200 is reached, the UAVs 120 are deployed by the portable launch platform 110.

The UAVs 120 communicate with one another and form a network. The network can be a wireless mesh network. For example, UAV 120d can use UAV 120b as a relay to transmit data to the portable launch platform 110. The portable launch platform 110 can transmit the data back to the ship or physically return to the ship once the UAVs 120 have completed the survey. In some implementations, the UAVs 120 communicate directly with the ship, and the portable launch platform 110 returns to the ship immediately once the UAVs 120 have been deployed to the local environment 200. The UAVs 120 spread out around the local environment 200 to maximize coverage for the survey. For example, UAV 120a maps the topological feature 240, which can be an ice shelf. UAV 120b maps topological feature 210. UAV 120c maps topological feature 230. UAV 120d maps the position of ice floe 220. Mapping the local environment 200 includes collecting image data, topography data, atmospheric data, and so forth.

FIG. 3 shows an example of a UAV 300 configured, e.g., for measuring atmospheric conditions. The UAV 300 is depicted as being located in the stratosphere, but it should be understood that the UAV 300 can travel to other layers of the atmosphere, such as the troposphere and the mesosphere, among others. The UAV 300 includes a frame 304 to which multiple rotors 306 are coupled. Each rotor 306 is coupled to a propeller 308. In some implementations, the rotors 306 and propellers 308 are part of a hybrid generator system, as described in detail below. The UAV 300 includes a sensor package 302. In some implementations, the sensor package 302 includes one or more sensors configured to measure one or more atmospheric conditions, such as temperature, barometric pressure, humidity, wind speed, wind direction, precipitation amounts, solar radiation, visibility, cloud ceiling, moisture content (e.g., for impurities, etc.), and air content (e.g., for particulates, etc.), among others. While the sensor package 302 is depicted as being a single device, it should be understood that in some implementations, the sensor package 302 includes a plurality of sensors. In some implementations, sensors of the sensor package 302 are each configured for measuring one or more atmospheric conditions. For example, the sensor package 302 may include a temperature sensor (e.g., a thermometer), a pressure sensor (e.g., a barometer), a humidity sensor (e.g., a hygrometer), a wind sensor (e.g., an anemometer), a solar radiation sensor (e.g., a pyranometer), a rain gauge, a disdrometer, a transmissometer, a ceilometer, etc. Similarly, while the sensor package 302 is depicted as being positioned outside of the UAV 300, in some implementations, the sensor package 302 may be positioned inside a housing of the UAV 300. In some implementations, one or more of the sensors that make up the sensor package 302 may be positioned inside of the housing of the UAV 300 and one or more of the sensors may be positioned outside of the housing of the UAV 300, e.g., depending on the design and/or function of the sensor.

In some implementations, the sensor package 302 is configured to measure impurities in moisture (e.g., precipitation, ambient moisture, etc.). For example, the sensor package 302 may be configured to measure one or more of pH, dissolved oxygen, oxidation-reduction potential, conductivity (e.g., salinity), turbidity, and dissolved ions such as Calcium, Nitrate, Fluoride, Iodine, Chloride, Cupric, Bromide, Silver, Fluoroborate, Ammonia, Lithium, Magnesium, Nitrite, Potassium, Sodium, and Perchlorate, among others.

In some implementations, the sensor package 302 is configured to measure particulates in air (e.g., ambient air). For example, the sensor package 302 may be configured to detect and/or measure suspended particulate matter, thoracic and respirable particles, inhalable coarse particles, fine particles of various dimensions, ultrafine particles, and soot, among others. In some implementations, the sensor package 302 is also configured to measure other parameters related to air quality and/or pollution, such as ozone, carbon monoxide, sulfur dioxide, and nitrous oxide, to name a few.

The UAV 300 can be used as a portable weather probe that is configured to travel to various longitudinal and latitudinal locations and through various altitudes in order to measure atmospheric conditions using the sensor package 302. Unlike traditional weather probes (e.g., weather balloons, weather sensors, etc.), the UAV 300 is equipped with a flight system (described in more detail below) that permits the UAV 300 to navigate freely. For example, by way of comparison, a weather balloon or other high-altitude balloon may be configured to attain a particular altitude but otherwise have no control over its direction (e.g., longitudinal and latitudinal direction) of travel. Once the weather balloon is released into the atmosphere, it may be unable to adjust its altitude until and unless it is landed and reconfigured. In contrast, the UAV 300 can actively adjust its direction of travel—both in latitudinal and longitudinal directions and in elevation—in real time.

In some implementations, the UAV itself can be used as a portable weather probe that travels in 3D space to sense atmospheric conditions at various locations. In addition to being capable of traveling to various longitudinal and latitudinal (e.g., x, y) coordinates, the UAV is able to easily adjust its altitude in order to sense atmospheric conditions at different atmospheric layers (e.g., the troposphere, stratosphere, mesosphere, etc.). In some implementations, the UAV may be instructed (e.g., manually or automatically) to move to a particular location based on one or more current or previously obtained measurements.

In some implementations, atmospheric conditions may be measured or inferred based on the UAV's response to such atmospheric conditions. For instance, information related to flight dynamics of the UAV may be used to measure changes in barometric pressure, wind speed, and wind direction, among others. Such measurements may be obtained by considering information logged by an avionics system and flight controller of the UAV.

In some implementations, the sensor package 302 includes a camera. The UAV 300 navigates the local environment, such as environment 200, to survey the local environment. For example, if searching for a missing person, the UAV 300 can capture image data that show signs that the person may be nearby, such as footprints, discarded equipment, etc. The image data can be combined with GPS data to pinpoint the missing person in a forest, mountain range, and so forth. In another example, if surveying the location of a plane crash over water, the UAV 300 can capture image data indicative of debris or other evidence that is not apparent in satellite imagery, due to a small size or obfuscation by the local environment.

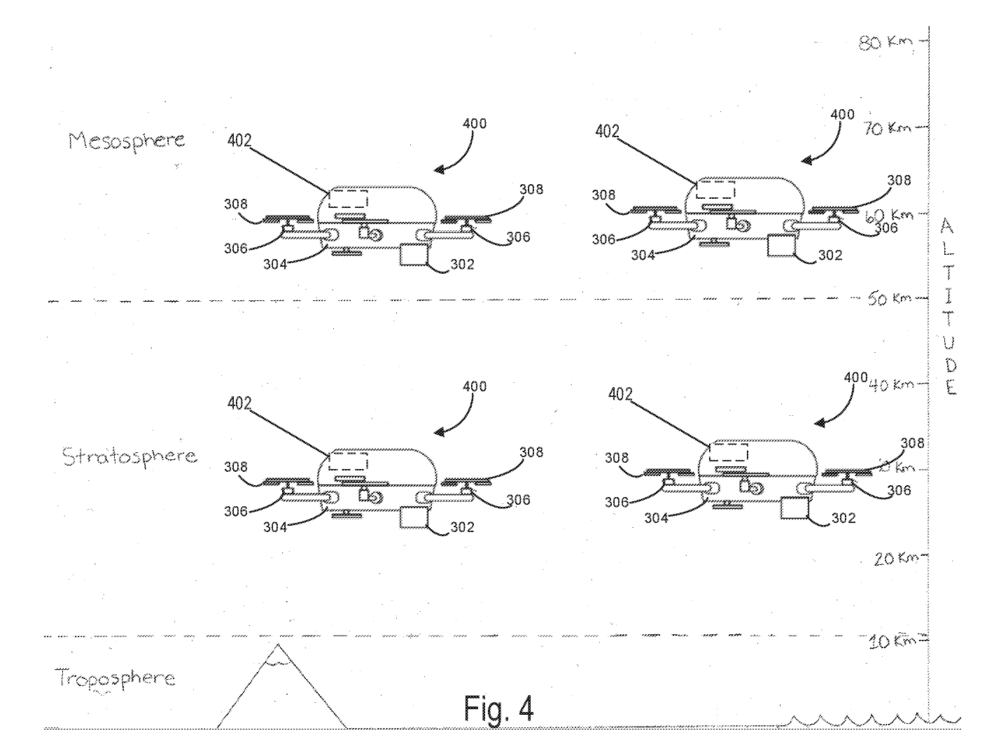

In some implementations, a plurality of UAVs 400 may be used to individually or collectively sense weather conditions. FIG. 4 shows an example of a sensor network 400 that includes a plurality of UAVs 400. The sensor network can be used, e.g., to determine a synchronized macro weather model. In some examples, a plurality of UAVs 400 (e.g., two, a dozen, tens, etc.) may be deployed across a local environment at various altitudes to determine a synchronized macro weather model. In this way, the sensor network can gather valuable atmospheric measurement information at various different locations simultaneously, thereby providing data that is more thorough and/or more accurate than that which is gathered by single-point sensor implementations. For example, weather prediction systems typically use mathematical models of the atmosphere to predict future weather based on current weather conditions. Such mathematical models rely on input data from weather sensors to determine current weather conditions in real-time. Additional input data, and in particular input data with high fidelity, allow the mathematical models to provide improved results. Input data provided by a plurality of sensor packages (e.g., the sensor packages 302 of the plurality of UAVs 400) across a geographic area can provide the mathematical models with data of the quality and quantity suitable to maximize the accuracy of weather predictions.

In some implementations, each UAV 400 includes a positional system such as a global positioning system (GPS) 402 for identifying the current location of the UAV 400. The GPS 402 may provide the location of the UAV 400 in terms of latitudinal and longitudinal coordinates. In some implementations, the GPS 402 may also provide information that can be used to determine the altitude of the UAV 400. In some implementations, a barometer (e.g., a barometer that is part of the sensor package 302) may be used to determine the altitude of the UAV 400. The current location of the UAV 400 can be mapped to the other atmospheric measurements made by the sensor package 302 to determine weather conditions that exist at a particular location (e.g., a particular longitude, latitude, and altitude) at a particular time. Such information may be provided to a mathematical weather model, and by employing numerical weather prediction and computer simulation techniques, future weather conditions can be predicted.

In some implementations, the UAVs 400 may be instructed to remain at a fixed location (e.g., at a fixed longitude, latitude, and altitude) as atmospheric measurements are collected. For example, the avionics systems and the flight controllers of the UAVs 400 may provide compensatory flight instructions to the respective UAVs 400 to ensure that the UAVs 400 maintain a straight and level hover. For example, if the compensatory flight instructions cause the UAV 400 to increase power to all rotors 306 equally in order to maintain the straight and level hover, this may indicate that a low-pressure condition having a particular magnitude exists at the location of the UAV 400, or a wind gust having a particular magnitude has occurred in a downwards direction over the UAV 400.

In some implementations, the UAVs 400 may be instructed to freely travel (e.g., by accepting limited compensatory flight instructions) according to the external weather conditions that exist. For example, wind gusts may cause the UAVs 400 to travel to various locations. The directions and distances that each UAV 400 travels may be used to infer information about the local weather conditions. For example, suppose one of the UAVs 400 travels in a north direction over a particular period of time. Positional information provided by the GPS 402 may be used to determine exactly where the UAV 400 traveled from and to, and the time period can be used to determine the average and instantaneous velocities of the UAV 400 over the course of travel. Such information can be used to infer characteristics of the wind (e.g., wind speed, wind direction, etc.) over the course of travel of the UAV 400.

In some implementations, the UAVs 400 may receive travel instructions that cause the sensor network 400 to travel as a group. For example, the UAVs 400 may be instructed to scan a particular geographic region (e.g., by “patrolling” the region). In some implementations, the sensor network 400 may be instructed to travel to a first particular geographic region, collect a particular number of atmospheric measurements, travel to a second particular geographic region, collect a particular number of atmospheric measurements, etc. In some implementations, the sensor network 400 may be instructed to remain in a particular geographic region for a particular amount of time before traveling to the next region. In some implementations, the sensor network 400 may be instructed to remain in a particular geographic region so long as the atmospheric measurements provide useful information. For example, the sensor network 400 may remain in a particular geographic region until the weather assumes a relatively calm state (e.g., as determined by whether one or more atmospheric measurements satisfy corresponding thresholds).

In some implementations, the UAVs 400 of the sensor network 400 may be instructed to travel and gather atmospheric measurements according to a set of predefined rules. For example, the sensor network 400 may infer locations at which valuable atmospheric measurements could be made based on one or more current or previously obtained atmospheric measurements. For example, current and previous wind and pressure measurements may indicate that inclement weather is present to the east of the current location of the sensor network 400. In response, the sensor network 400 may be automatically instructed to travel east. The particular locations of increment weather may be based on information provided by a mathematical weather model that utilizes computer simulations. The mathematical weather model may consider atmospheric measurements currently provided or previously provided by the sensor packages 302 of the UAVs 400.

In some implementations, the portable launch platform 110 can be powered by a hybrid generator system that provides a portable hybrid generator power source with energy conversion efficiency. In UAV applications, the hybrid generator system can be used to overcome the weight of the vehicle, the hybrid generator drive, and fuel used to provide extended endurance and payload capabilities in UAV applications.

The hybrid generator system can include two separate power systems. A first power system included as part of the hybrid generator system can be an efficient gasoline powered engine coupled to a generator motor. The first power system can serve as a primary source of power of the hybrid generator system. A second power system, included as part of the hybrid generator system, can be a high energy density rechargeable battery. Together, the first power system and the second power system combine to form a high-energy continuous power source and with high peak power availability for a UAV. In some examples, one of the first power system and the second power system can serve as a back-up power source of the hybrid generator system if the other power system experiences a failure.

FIG. 5 shows a diagram of an example hybrid generator system 500. The hybrid generator system 500 includes a fuel source 502 (e.g., a vessel) for storing gasoline, a mixture of gasoline and oil mixture, or similar type fuel or mixture. The fuel source 502 provides fuel to an engine 504 of a first power system. The engine 504 can use the fuel provided by the fuel source 502 to generate mechanical energy. In some examples, the engine 504 can have dimensions of about 12″ by 11″ by 6″ and a weight of about 3.5 lbs. to allow for integration in a UAV. In some examples, the engine 504 may be an HWC/Zenoah G29 RCE 3D Extreme available from Zenoah, 1-9 Minamidai Kawagoe, Saitama 350-2025, Japan. The hybrid generator system 500 also includes a generator motor 506 coupled to the engine 504. The generator motor 506 functions to generate AC output power using mechanical power generated by the engine 504. In some examples, a shaft of the engine 504 includes a fan that dissipates heat away from the engine 504. In some examples, the generator motor 506 is coupled to the engine 504 through a polyurethane coupling.

In some examples, the hybrid generator system 500 can provide 1.8 kW of power. The hybrid generator system 500 can include an engine 504 that provides approximately 3 horsepower and weighs approximately 1.5 kg. In some examples, the engine 504 may be a Zenoah® G29RC Extreme engine. The hybrid generator system 500 can include a generator motor 506 that is a brushless motor, such as a 380 Kv, 8 mm shaft, and part number 5035-380, available from Scorpion Precision Industry®.

In some examples, the hybrid generator system 500 can provide 10 kW of power. The hybrid generator system 500 can include an engine 504 that provides approximately between 15-16.5 horsepower and weighs approximately 7 pounds. In some examples, the engine 504 is a Desert Aircraft® D-150. The hybrid generator system 500 can include a generator motor 506, such as a Joby Motors® JM1 motor.

The hybrid generator system 500 includes a bridge rectifier 508 and a rechargeable battery 510. The bridge rectifier 508 is coupled between the generator motor 506 and the rechargeable battery 510 and converts the AC output of the generator motor 506 to DC power to charge the rechargeable battery 510 or provide DC power to load 518 by line 520 or power to DC-to-AC inverter 522 by line 524 to provide AC power to load 526. The rechargeable battery 510 may provide DC power to load 528 by line 530 or to DC-to-AC inverter 532 by line 534 to provide AC power to load 536. In some examples, an output of the bridge rectifier 508 and/or the rechargeable battery 510 of hybrid generator system 500 is provided by line 538 to one or more electronic speed control devices (ESC) 514 integrated in one or more rotor motors 516 as part of a UAV. The ESC 514 can control the DC power provided by bridge rectifier 508 and/or rechargeable battery 510 to one or more rotor motors provided by generator motor 506. In some examples, the ESC 514 can be a T-Motor® ESC 45A (2-6S) with SimonK. In some examples, the bridge rectifier 508 can be a model #MSD100-08, diode bridge 800V 100A SM3, available from Microsemi Power Products Group®. In some examples, active rectification can be applied to improve efficiency of the hybrid generator system.

In some examples, the ESC 514 can control an amount of power provided to one or more rotor motors 516 in response to input received from an operator. For example, if an operator provides input to move a UAV to the right, then the ESC 514 can provide less power to rotor motors 516 on the right of the UAV to cause the rotor motors to spin propellers on the right side of the UAV slower than propellers on the left side of the UAV. As power is provided at varying levels to one or more rotor motors 516, a load (e.g., an amount of power provided to the one or more rotor motors 516) can change in response to input received from an operator.

In some examples, the rechargeable battery 510 may be a LiPo battery, providing 3000 mAh, 22.2V 65 C, Model PLU65-30006, available from Pulse Ultra Lipo®, China. In some examples, the rechargeable battery 510 may be a lithium sulfur (LiSu) rechargeable battery or similar type of rechargeable battery.

The hybrid generator system 500 includes an electronic control unit (ECU) 512. The ECU 512, and other applicable systems described herein, can be implemented as a computer system, a plurality of computer systems, or parts of a computer system or a plurality of computer systems. The computer system may include a processor, memory, non-volatile storage, and an interface. A typical computer system will usually include at least a processor, memory, and a device (e.g., a bus) coupling the memory to the processor. In some examples, the processor may be a general-purpose central processing unit (CPU), such as a microprocessor, or a special-purpose processor, such as a microcontroller.

In some examples, the memory can include random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data may be written, by a direct memory access process, into memory during execution of software on the computer system. The non-volatile storage can be local, remote, or distributed. The non-volatile storage may be optional because systems can be created with all applicable data available in memory.

Software is typically stored in the non-volatile storage. In some examples (e.g., for large programs), it may not be practical to store the entire program in the memory. Nevertheless, it should be understood that the software may be moved to a computer-readable location appropriate for processing, and for illustrative purposes, that location is referred to as the memory herein. Even when software is moved to the memory for execution, the processor will typically make use of hardware registers to store values associated with the software, and local cache that, in some examples, serves to speed up execution. As used herein, a software program may be stored at an applicable known or convenient location (e.g., from non-volatile storage to hardware registers) when the software program is referred to as “implemented in a computer-readable storage medium.” A processor is “configured to execute a program” when at least one value associated with the program is stored in a register readable by the processor.

In some examples of operation, a computer system can be controlled by operating system software, such as a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. In some examples, the I/O devices can include a keyboard, a mouse or other pointing device, disk drives, printers, a scanner, and other I/O devices, including a display device. In some examples, the display device can include a cathode ray tube (CRT), liquid crystal display (LCD), or some other applicable known or convenient display device. The interface can include one or more of a modem or network interface. It will be appreciated that a modem or network interface can be considered part of the computer system. The interface can include one or more of an analog modem, isdn modem, cable modem, token ring interface, Ethernet interface, satellite transmission interface (e.g. “direct PC”), or other interfaces for coupling a computer system to other computer systems. Interfaces enable computer systems and other devices to be coupled in a network.

A computer system can be implemented as a module, as part of a module, or through multiple modules. As used herein, a module can include one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the module's functionality, or the like. As such, a first module and a second module can have one or more dedicated processors, or a first module and a second module can share one or more processors with one another or other modules. Depending upon implementation-specific or other considerations, in some examples, a module can be centralized or its functionality distributed. A module can include hardware, firmware, or software embodied in a computer-readable medium for execution by the processor. The processor can transform data into new data using implemented data structures and methods, such as is described with reference to the figures included herein.

The ECU 512 is coupled to the bridge rectifier 508 and the rechargeable battery 510. The ECU 512 can be configured to measure the AC voltage of the output of the generator motor 506, which is directly proportional to the revolutions per minute (RPM) of the engine 504, and compares it to the DC power output of the bridge rectifier 508. The ECU 512 can control the throttle of the engine 504 to cause the DC power output of the bridge rectifier 508 to increase or decrease as the load changes (e.g., a load of one or more electric motors 516 or one or more of loads 518, 526, 528, and 536). In some examples, the ECU 512 can be an Arduino® MEGA 2560 Board R3, available from China. In various embodiments, a load of one or more electric motors 516 can change as the ESC 514 changes an amount of power provided to the electric motors 516. For example, if a user inputs to increase the power provided to the electric motors 516 subsequently causing the ESC 514 to provide more power to the electric motors 516, then the ECU 512 can increase the throttle of the engine 504 to cause the production of more power to be provided to the electronic motors 516.

The ECU 512 can function to maintain voltage output of loads by reading the sensed analog voltage, converting the sensed analog voltage to ADC counts, comparing the count to that corresponding to a desired voltage, and increasing or decreasing the throttle of the engine 504 according to the programmed gain if the result is outside of the dead band.

In some examples, the hybrid generator system 500 can provide about 1,800 watts of continuous power, 10,000 watts of instantaneous power (e.g., 6S with 16,000 mAh pulse battery) and has a 1,500 Wh/kg gasoline conversion rate. In some examples, the hybrid generator system 500 has dimensions of about 12″ by 12″ by 12″ and a weight of about 8 lbs.

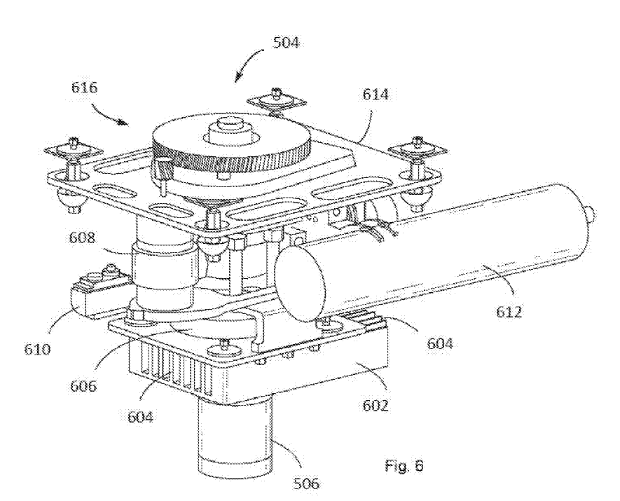

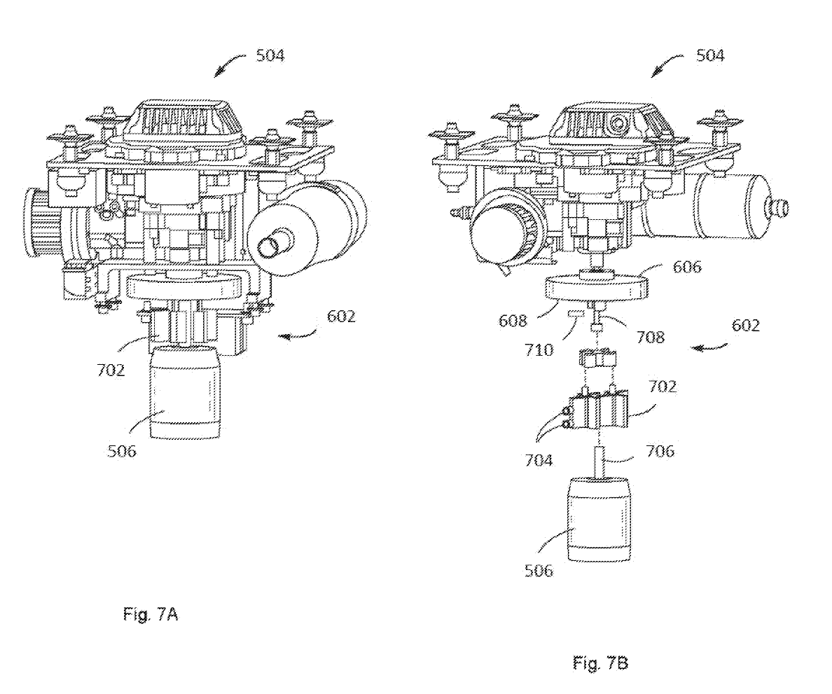

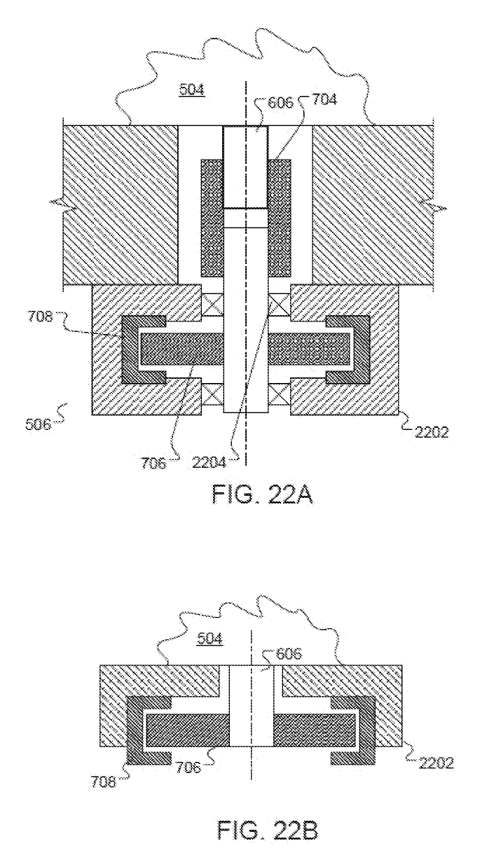

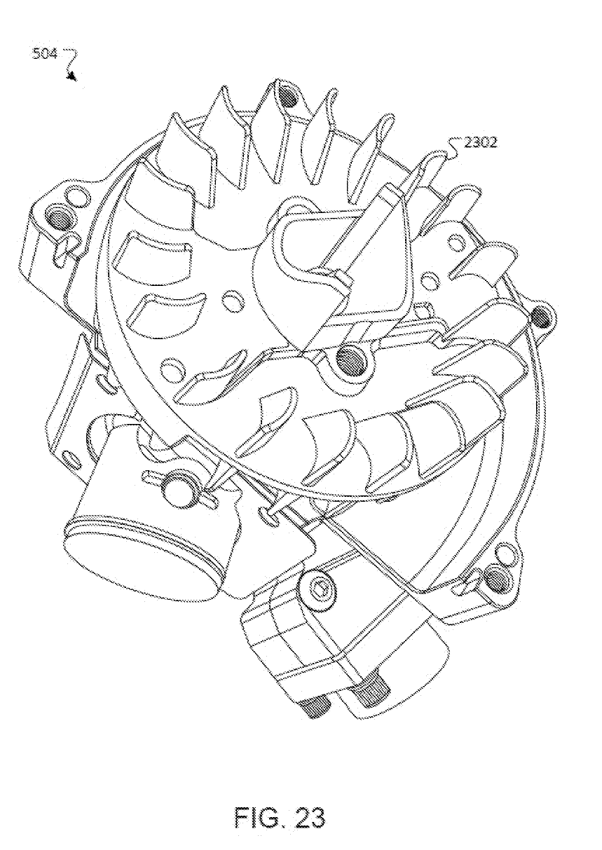

FIG. 6 shows a side perspective view of a hybrid generator system 500. FIG. 7A shows a side view of a hybrid generator 500. FIG. 7B shows an exploded side view of a hybrid generator 500. The hybrid generator system 500 includes an engine 504 coupled to generator motor 506. In one embodiment, the engine 504 includes a coupling/cooling device 602 that provides coupling of the shaft of the generator motor 506 to the shaft of the engine 504 and provides cooling with sink fins 604. For example, FIGS. 7A and 7B show in further detail one embodiment of coupling/cooling device 602, which includes coupling/fan 702 with setscrews 704 that couple shaft 706 of generator motor 506 and shaft 708 of the engine 504. Coupling/cooling device 602 may also include rubber-coupling ring (2202 of FIG. 22A).

In some examples, the hybrid generator system 500 includes components to facilitate transfer of heat away from the hybrid generator system 500 and/or is integrated within a UAV to increase airflow over components that produce heat. For example, the hybrid generator system 500 can include cooling fins on specific components (e.g. the rectifier) to transfer heat away from the hybrid generator system. In some examples, the hybrid generator system 500 includes components and is integrated within a UAV to cause heat to be transferred towards the exterior of the UAV.

In some examples, the hybrid generator system 500 and/or a UAV integrating the hybrid generator system 500 is configured to allow 406 cubic feet per minute of airflow across at least one component of the hybrid generator system 500. A engine 504 of the hybrid generator system 500 can be run at an operating temperature 150° C. and if an ambient temperature in which the hybrid generator system 500, in order to remove heat generated by the engine 506, an airflow of 406 cubic feet per minute is achieved across at least the engine 506. Further, in some examples, the engine 506 is operated at 16.5 Horsepower and generates 49.2 kW of waste heat (e.g. each head of the engine produces 24.6 kW of waste heat). In some examples, engine heads of the engine 506 of the hybrid generator system 500 are coupled to electric ducted fans to concentrate airflow over the engine heads. For example, 406 cubic feet per minute airflow can be achieved over engine heads of the engine 506 using electric ducted fans.

In some examples, the hybrid generator system 500 is integrated as part of a UAV using a dual vibration damping system. A engine 506 of the hybrid generator system can utilize couplings to serve as dual vibration damping systems. In some examples, the engine 506 produces a mean torque of 1.68 Nm at 10,000 RPM. In some examples, a urethane coupling is used to couple at least part of the hybrid generator system 500 to a UAV. Further, in some examples, the urethane coupling can have a durometer value of between 90A to 75D. Example urethane couplings used to secure at least part of the hybrid generator system 500 to a UAV include L42 Urethane, L100 Urethane, L167 Urethane, and L315 Urethane. Urethane couplings used to secure at least part of the hybrid generator system 500 to a UAV can have a tensile strength between 20 MPa and 62.0 MPa, between 270 to 800% elongation at breaking, a modulus between 2.8 MPa and 32 MPa, an abrasion index between 110% and 435%, and a tear strength split between 12.2 kN/m and 192.2 kN/m.

The engine 504 also includes a flywheel 606 that can reduce mechanical noise and/or engine vibration. In some examples, engine 504 includes a Hall-Effect sensor (710 of FIG. 7A) and a Hall Effect magnet coupled to fly wheel 606, as shown. In some examples, the Hall-effect sensor 710 may be available from RCexl Min Tachometer®, Zhejiang Province, China. When engine 504 is operational, fly wheel 606 spins and generates a voltage that is directly proportional to the revolutions per minute of flywheel 606. This voltage is measured by Hall-effect sensor 710 and is input into an ECU 512. The ECU 512 compares the measured voltage to the voltage output by generator motor 506. ECU 512 will then control the throttle of either or both the generator motor 506 and the engine 504 to increase or decrease the voltage as needed to supply power to one or more of loads 518, 526, 528, and/or 536 or one or more rotor motors 516.

Small engine 504 may also include a starter motor 608, servo 610, muffler 612, and vibrational mount 614.

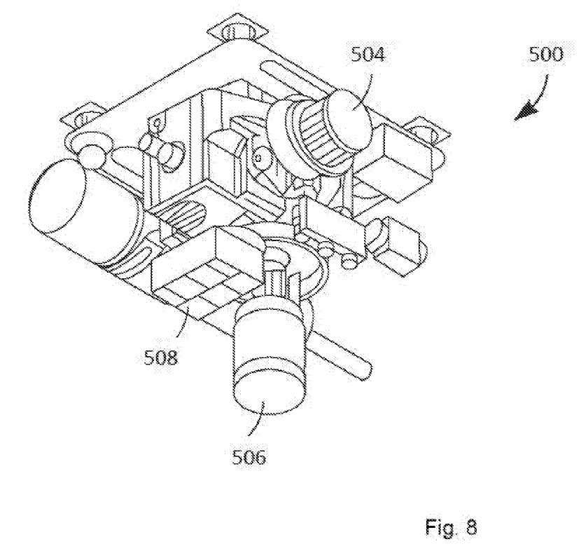

FIG. 8 shows a perspective view of a hybrid generator system 500. The hybrid generator system 500 includes a motor 504 and generator motor 506 coupled to a bridge rectifier 508.

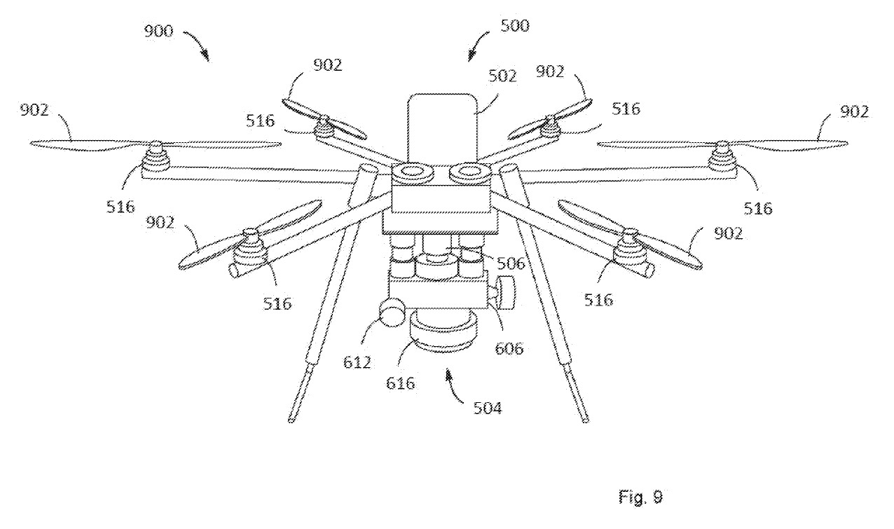

FIG. 9 shows a perspective view of a UAV 900 integrated with a hybrid generator system 500. The UAV 900 includes six rotor motors 516 each coupled to propellers 902; however, it is appreciated that a UAV integrated with a hybrid generator system 500 can include more or fewer rotor motors and propellers. The UAV 900 can include a Px4 flight controller manufactured by Pixhawk®.

In some examples, the engine 504 may be started using an electric starter (616 of FIGS. 6 and 9). Fuel source 502 can deliver fuel to engine 504 to spin its rotor shaft directly coupled to generator motor 506 (e.g., as shown in FIG. 7) and applies a force to generator motor 506. The spinning of generator motor 506 generates electricity and the power generated by motor generator 506 is proportional to the power applied by shaft of engine 504. In some examples, a target rotational speed of generator motor 506 is determined based on the KV (rpm/V) of generator motor 506. For example, if a target voltage of 25 Volt DC is desired, the rating of generator motor 506 may be about 400 KV. The rotational speed of the engine 504 may be determined by the following equations:

RPM=KV (RPM/Volt)×Target Voltage (VDC) (2)

RPM=400 KV×25 VDC (3)

RPM=10,000 (4)

In this example, for generator motor 506 to generate 25 VDC output, the shaft of generator motor 506 coupled to the shaft of engine 504 needs to spin at about 10,000 RPM.

As the load (e.g., one or more motors 516 or one or more of loads 518, 526, 528, and/or 536) is applied to the output of generator motor 506, the voltage output of the hybrid generator system 500 will drop, thereby causing the speed of engine 504 and generator motor 506 to be reduced. In some examples, ECU 512 can be used to help regulate the throttle of engine 504 to maintain a consistent output voltage that varies with loads. ECU 512 can act in a manner similar to that of a standard governor for gasoline engines, but instead of regulating an RPM, the ECU 512 can regulate a target voltage output of either or both a bridge rectifier and a generator motor 506 based on a closed loop feedback controller.

Power output from generator motor 506 can be in the form of alternating current (AC) which may need to be rectified by bridge rectifier 508. Bridge rectifier 508 can convert the AC power into direct current (DC) power, as discussed above. In some examples, the output power of the hybrid generator system 500 can be placed in a “serial hybrid” configuration, where the generator power output by generator motor 506 may be available to charge the rechargeable battery 510 or provide power to another external load.

In operation, there can be at least two available power sources when the hybrid generator system 500 is functioning. A primary source can be from the generator motor 506 through directly from the bridge rectifier and a secondary power source can be from the rechargeable battery 510. Therefore, a combination of continuous power availability and high peak power availability is provided, which may be especially well suited for UAV applications or portable generator applications. In cases where either primary power source (e.g., generator motor 506) is not available, system 500 can continue to operate for a short period of time using power from rechargeable battery 510, thereby allowing a UAV to sustain safety strategy, such as an emergency landing.

When hybrid generator system 500 is used for UAVs, the following conditions can be met to operate the UAV effectively and efficiently: 1) the total continuous power (watts) can be greater than power required to sustain UAV flight, 2) the power required to sustain a UAV flight is a function of the total weight of the vehicle, the total weight of the hybrid engine, the total weight of fuel, and the total weight of the payload), where:

Total Weight (gram)=vehicle dry weight+engine weight+fuel weight+payload (5)

and, 3) based on the vehicle configuration and aerodynamics, a particular vehicle will have an efficiency rating (grams/watt) of 11, where:

Total Power Required to Fly=η×Weight (gram) (6)

In examples in which the power required to sustain flight is greater than the available continuous power, the available power or total energy may be based on the size and configuration of the rechargeable battery 510. A configuration of the rechargeable battery 510 can be based on a cell configuration of the rechargeable battery 510, a cell rating of the rechargeable battery 510, and/or total mAh of the rechargeable battery 510. In some examples, for a 6S, 16000 mAh, 25 C battery pack, the total energy is determined by the following equations:

Total Energy=Voltage×mAh=25 VDC (6S)×16000 mAh=400 Watt*Hours (7)

Peak Power Availability=Voltage×mAh×C Rating=25 VDC×16000 mAh×25 C 10,400 Watts (8)

Total Peak Time=400 Watt*Hours/10,400 Watts=138.4 secs (9)

Further, in some examples, the rechargeable battery 510 may be able to provide 10,400 Watts of power for 138.4 seconds in the event of primary power failure from engine 504. Additionally, the rechargeable battery 510 may be able to provide up to 10,400 Watts of available power for flight or payload needs instantaneous peak power for short periods of time needed for aggressive maneuvers.

The result is hybrid generator system 500, when coupled to a UAV, efficiently and effectively provides power to fly and maneuver the UAV for extended periods of time with higher payloads than conventional multi-rotor UAVs. In some examples, the hybrid generator system 500 can provide a loaded (e.g., 3 lb. load) flight time of up to about 2 hours 5 minutes, and an unloaded flight time of about 2 hours and 35 minutes. Moreover, in the event that the fuel source runs out or the engine 504 and/or he generator motor 506 malfunctions, the hybrid generator system 500 can use the rechargeable battery 510 to provide enough power to allow the UAV to perform a safe landing. In some examples, the rechargeable battery 510 can provide instantaneous peak power to a UAV for aggressive maneuvers, for avoiding objects, or threats, and the like.

In some examples, the hybrid generator system 500 can provide a reliable, efficient, lightweight, portable generator system that can be used in both commercial and residential applications to provide power at remote locations away from a power grid and for a micro-grid generator, or an ultra-micro-grid generator.

In some examples, the hybrid generator system 500 can be used for an applicable application (e.g., robotics, portable generators, micro-grids and ultra-micro-grids, and the like) where an efficient high energy density power source is desired and where a fuel source is readily available to convert hydrocarbon fuels into useable electric power. The hybrid generator system 500 has been shown to be significantly more energy efficient than various forms of rechargeable batteries (Lithium Ion, Lithium Polymer, Lithium Sulfur) and even Fuel Cell technologies typically used in conventional UAVs.

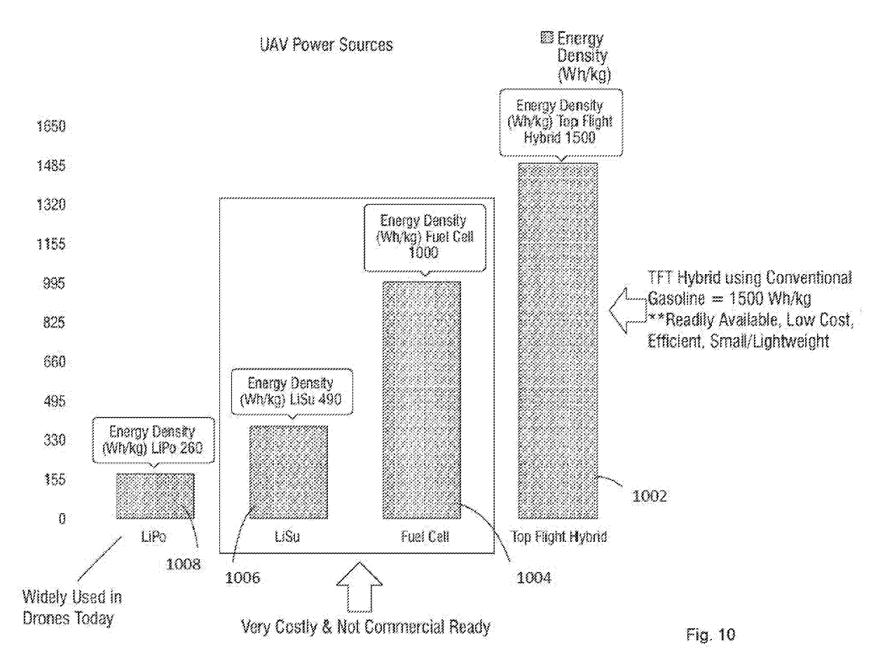

FIG. 10 shows a graph comparing energy density of different UAV power sources. In some examples, the hybrid generator system 500 can use conventional gasoline, which is readily available at low cost and provide about 1,500 Wh/kg of power for UAV applications, as indicated at 1002 in FIG. 6. UAVs that rely entirely on batteries can provide a maximum energy density of about 1,000 Wh/kg when using an energy high-density fuel cell technology, as indicated at 1004, about 400 Wh/kg when using lithium sulfur batteries, as indicated at 1006, and about 200 Wh/kg when using a LiPo battery, as indicated at 1008.

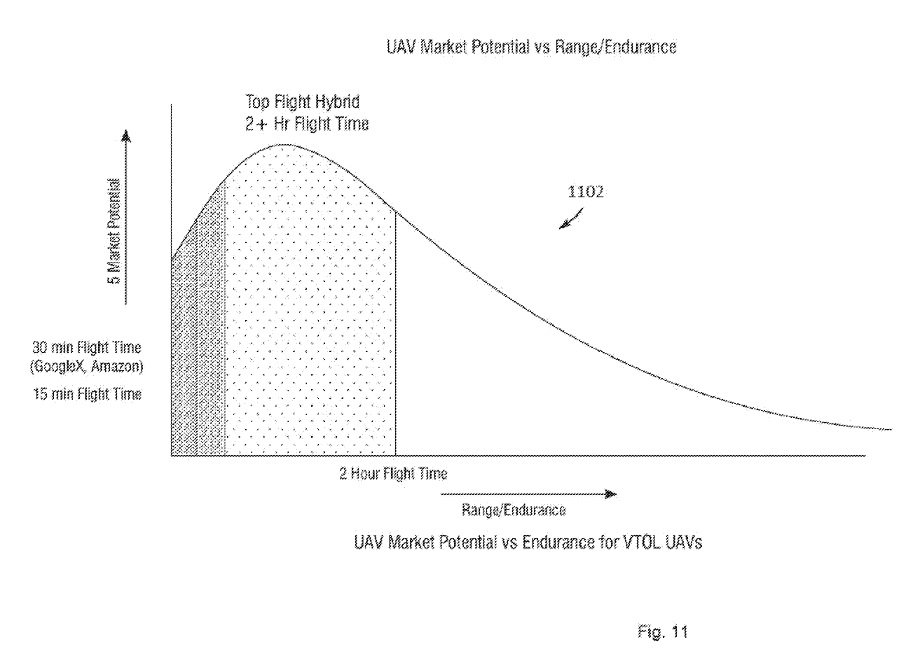

FIG. 11 shows a graph 1104 of market potential for UAVs against flight time for an example two plus hours of flight time hybrid generator system 500 when coupled to a UAV is able to achieve and an example of the total market potential vs. endurance for the hybrid generator system 500 for UAVs.

In some examples, the hybrid generator power systems 500 can be integrated as part of a UAV or similar type aerial robotic vehicle to perform as a portable flying generator using the primary source of power to sustain flight of the UAV and then act as a primary power source of power when the UAV has reached its destination and is not in flight. For example, when a UAV which incorporates the hybrid generator power system 500 (e.g., the UAV 900 of FIG. 9) is not in flight, the available power generated by hybrid system can be transferred to one or more of external loads 518, 526, 528, and/or 536 such that hybrid generator system 500 operates as a portable generator. The hybrid system generator 500 can provide continuous peak power generation capability to provide power at remote and often difficult to reach locations. In the “non-flight portable generator mode,” hybrid system 500 can divert the available power generation capability towards external one or more of loads 518, 526, 528, and/or 536. Depending on the power requirements, one or more of DC-to-AC inverters 522, 532 may be used to convert DC voltage to standard AC power (120 VAC or 240 VAC).

In some examples, hybrid generator system 500 coupled to a UAV (e.g., UAV 900 of FIG. 9) will be able to traverse from location to location using aerial flight, land, and switch on the power generator to convert fuel into power.

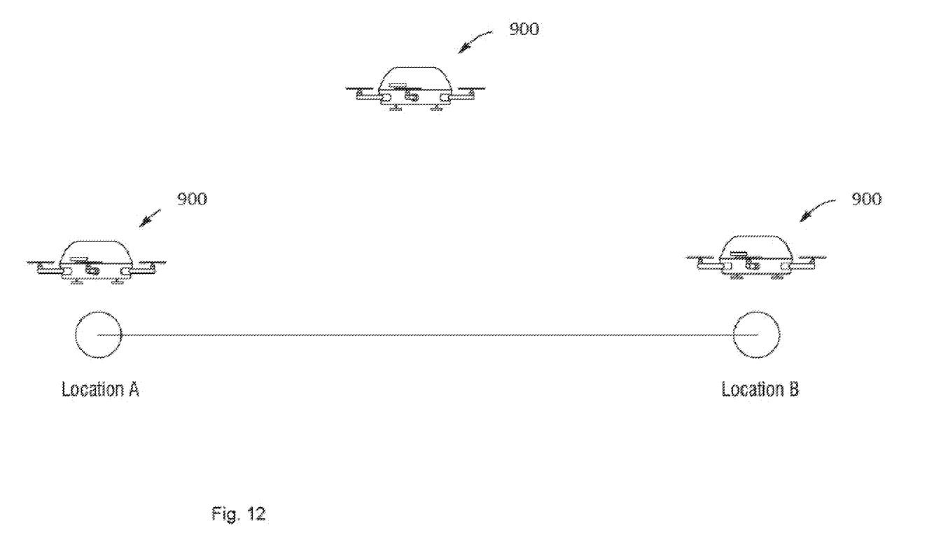

FIG. 12 shows an example flight pattern of a UAV (e.g., portable launch platform 110 of FIG. 1) with a hybrid generator system 500. In the example flight pattern shown in FIG. 12, the UAV 900, with hybrid system 500 coupled thereto, begins at location A loaded with fuel ready to fly. The UAV 900 then travels from location A to location B and lands at location B. The UAV 900 then uses hybrid system 500 to generate power for local use at location B, thereby acting as a portable flying generator. For example, the UAV 900 can act as a charging station for the UAVs 120 of FIG. 1. When power is no longer needed, the UAV 900 returns back to location A and awaits instructions for the next task.

In some examples, the UAV 900 uses the power provided by hybrid generator system 500 to travel from an initial location to a remote location, fly, land, and then generate power at the remote location. Upon completion of the task, the UAV 900 is ready to accept commands for its new task. All of this can be performed manually or through an autonomous/automated process. In some examples, the UAV 900 with hybrid generator system 500 can be used in an applicable application where carrying fuel and a local power generator are needed. Thus, the UAV 900 with a hybrid generator system 500 eliminates the need to carry both fuel and a generator to a remote location. The UAV 900 with a hybrid generator system 500 is capable of powering both the vehicle when in flight, and when not in flight can provide the same amount of available power to external loads. This may be useful in situations where power is needed for the armed forces in the field, in humanitarian or disaster relief situations where transportation of a generator and fuel is challenging, or in situations where there is a request for power that is no longer available, to name a few.

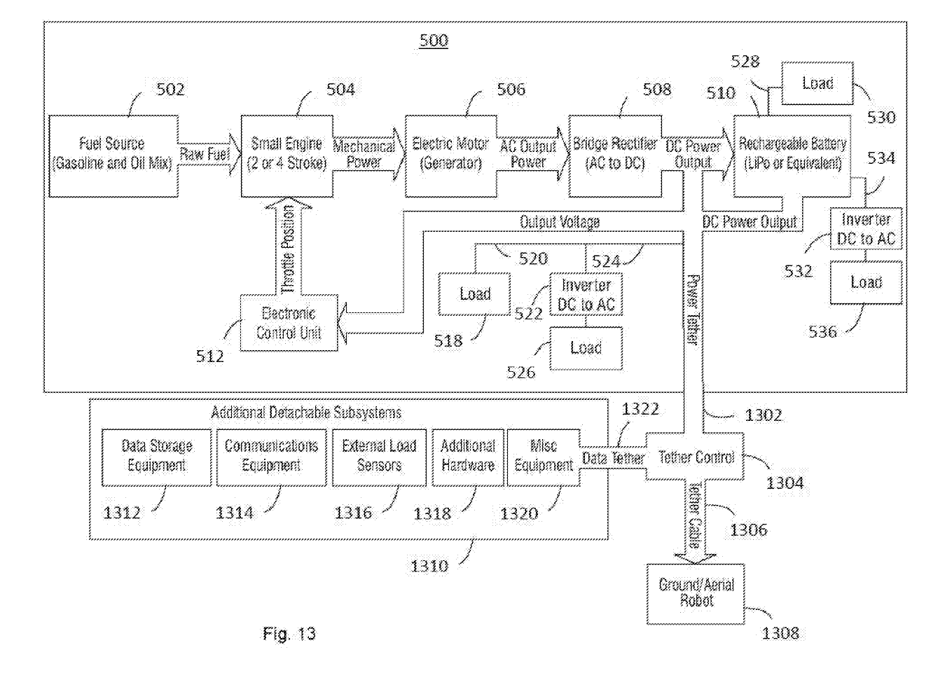

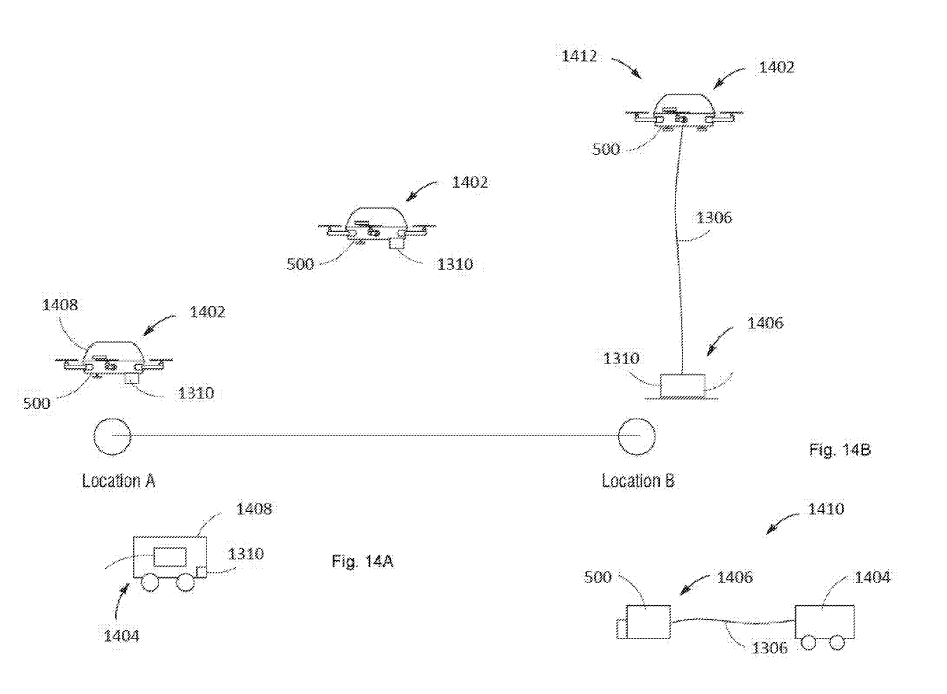

FIG. 13 shows a diagram of another system for a hybrid generator system 500 with detachable subsystems. FIG. 14A shows a diagram of a hybrid generator system 500 with detachable subsystems integrated as part of a UAV. FIG. 14B shows a diagram of a hybrid generator system 500 with detachable subsystems integrated as part of a ground robot. In some examples, a tether line 1302 is coupled to the DC output of bride rectifier 508 and rechargeable battery 510 of a hybrid control system 500. The tether line 1302 can provide DC power output to a tether controller 1304. The tether controller 1304 is coupled between a tether cable 1306 and a ground or aerial robot 1308. In operation, as discussed in further detail below, the hybrid generator system 500 provides tethered power to the ground or aerial robot 1308 with the similar output capabilities as discussed above with respect to one or more of the figures included herein, such as portable launch platform 110 of FIG. 1.

The system shown in FIG. 13 can include additional detachable components 1310 integrated as part of the system. For example, the system can include data storage equipment 1312, communications equipment 1314, external load sensors 1316, additional hardware 1318, and various miscellaneous equipment 1320 that can be coupled via data tether 1322 to tether controller 1304.

In some examples of operation of the system shown in FIG. 13, the system may be configured as part of a flying robot or UAV, such as flying robot or UAV (1402 of FIG. 14 or portable launch platform 110 of FIG. 1), or as ground robot 1404. Portable tethered robotic system 1408 may start a mission at location A. All or an applicable combination of the subsystems and ground, the tether controller, ground/aerial robot 1308 can be powered by the hybrid generator system 500. The portable tethered robotic system 1408 can travel either by ground (e.g., using ground robot 1404 powered by hybrid generator system 500) or by air (e.g., using flying robot or UAV 1402 powered by hybrid generator system 500) to desired remote location B. At location B, portable tethered robotic system 1408 configured as flying robot 1402 or ground robot 1404 can autonomously decouple hybrid generator system 500 and/or detachable subsystem 1310, indicated at 1406, which remain detached while ground robot 1404 or flying robot or UAV 1402 are operational. When flying robot or UAV 1402 is needed at location B, indicated at 1412, flying robot or UAV 1402 can be operated using power provided by hybrid generator system coupled to tether cable 1306. When flying robot or UAV 1402 no longer has hybrid generator system 500 and/or additional components 1310 attached thereto, it is significantly lighter and can be in flight for a longer period of time. In some examples, flying robot or UAV 1402 can take off and remain in a hovering position remotely for extended periods of time using the power provided by hybrid generator system 500.

Similarly, when ground robot 1404 is needed at location B, indicated at 1410, it may be powered by hybrid generator system 500 coupled to tether line 1306 and may also be significantly lighter without hybrid generator system 500 and/or additional components 1310 attached thereto. Ground robot 1404 can also be used for extended periods of time using the power provide by hybrid generator system 500.

The portable launch system 100 includes one or more UAVs 120 that are not tethered to the portable launch platform 110. Rather, the UAVs 120 (described above in relation to FIGS. 1-4) are free to navigate a local environment without requiring external power from UAV 1402, or the portable launch platform 110 of FIG. 1.

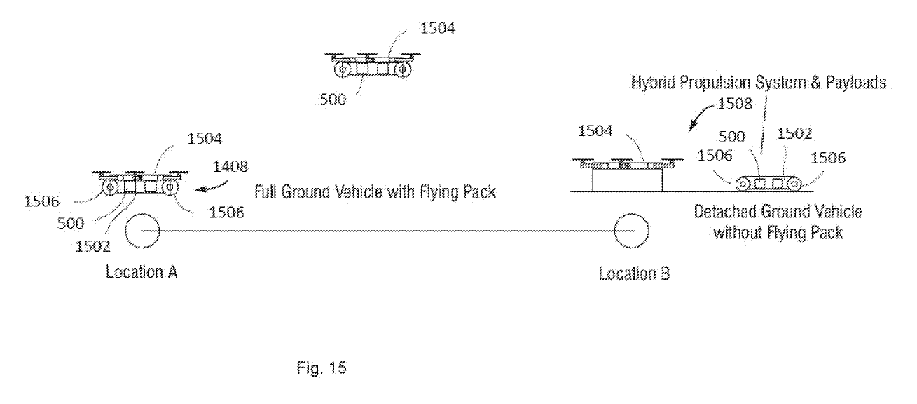

FIG. 15 shows a ground robot 1502 with a detachable flying pack 1504 in operation. The detachable flying pack 1504 includes hybrid generator system 500. The detachable flying pack 1504 is coupled to the ground robot 1502 of one or more embodiments. The hybrid generator system 500 is embedded within the ground robot 1502. The ground robot 1502 is detachable from the flying pack 1504. With such a design, a majority of the capability may be embedded deep within the ground robot 1502, which can operate 100% independently of the flying pack 1504. When the ground robot 1502 is attached to the flying pack 1504, the flying pack 1504 may be powered from hybrid generator system 500 embedded in the ground robot 1502 and the flying pack 1504 provides flight. The ground robot 1502 platform can be a leg wheel or threaded base motion.

In some examples, the ground robot 1502 may include the detachable flying pack 1504 and the hybrid generator system 500 coupled thereto as shown in FIG. 15. In the illustrated example, the ground robot 1502 is a wheel-based robot as shown by wheels 1506. In this example, the hybrid generator system 500 includes fuel source 502, engine 504, generator motor 506, bridge rectifier 508, rechargeable battery 20, ECU 512, and optional inverters 522 and 532, as discussed above with reference to one or more figures included herein. The hybrid generator system 500 also preferably includes data storage equipment 1312, communications equipment 1314, external load sensors 1316, additional hardware 1318, and miscellaneous communications 1320 coupled to data line 1322 as shown. The flying pack 1504 is preferably an aerial robotic platform such as a fixed wing, single rotor or multi rotor, aerial device, or similar type aerial device.

In some examples, the ground robot 1502 and the aerial flying pack 1504 are configured as a single unit. Power is delivered from hybrid generator system 500 and is used to provide power to flying pack 1504, so that ground robot 1502 and flying pack 1504 can fly from location A to location B. At location B, ground robot 1506 detaches from flying pack 1504, indicated at 1508, and is able to maneuver and operate independently from flying pack 1504. Micro hybrid generator system 500 is embedded in ground robot 1502 such that ground robot 1506 can be independently powered from flying pack 1504. Upon completion of the ground mission, ground robot 1502 is able to reattach itself to flying pack 1504 and return to location A. All of the above operations can be manual, semi-autonomous, or fully autonomous.

In some examples, flying pack 1504 can traverse to a remote location and deliver ground robot 1502. At the desired location, there may be no need for flying pack 1504. As such, it can be left behind so that ground robot 1502 can complete its mission without having to carry flying pack 1504 as its payload. This may be useful for traversing difficult and challenging terrains, remote locations, and in situations where it is challenging to transport ground robot 1502 to the location. Exemplary applications may include remote mine destinations, remote surveillance and reconnaissance, and package delivery services where flying pack 1504 cannot land near an intended destination. In these examples, a designated safe drop zone for flying pack can be used and local delivery is completed by ground robot 1502 to the destination.

In some examples, upon a mission being completed, ground robot 1404 or flying robot or UAV 1402 can be autonomously coupled back to hybrid generator system 500. In some implementations, such coupling is performed automatically upon the mission being completed. Additional detachable components 1310 can be autonomously coupled back hybrid generator system 500. Portable tethered robotic system 1408 with a hybrid generator system 500 configured a flying robot or UAV 1402 or ground robot 1404 then returns to location A using the power provided by hybrid generator system 500.

The result is portable tethered robotic system 1408 with a hybrid generator system 500 is able to efficiently transport ground robot 1404 or flying robot or UAV 1402 to remote locations, automatically decouple ground robot 1404 or flying robot or UAV 1402, and effectively operate the flying robot 1402 or ground robot 1404 using tether power where it may be beneficial to maximize the operation time of the ground robot 1402 or flying robot or UAV 1404. System 1408 provides modular detachable tethering which may be effective in reducing the weight of the tethered ground or aerial robot, thereby reducing its power requirements significantly. This allows the aerial robot or UAV or ground robot to operate for significantly longer periods of time when compared to the original capability where the vehicle components are attached and the vehicle needs to sustain motion. System 1408 eliminates the need to assemble a generator, robot and tether at remote locations and therefore saves time, resources, and expense. Useful applications of system 1408 may include, inter alia, remote sensing, offensive or defensive military applications and/or communications networking, multi-vehicle cooperative environments, and the like.

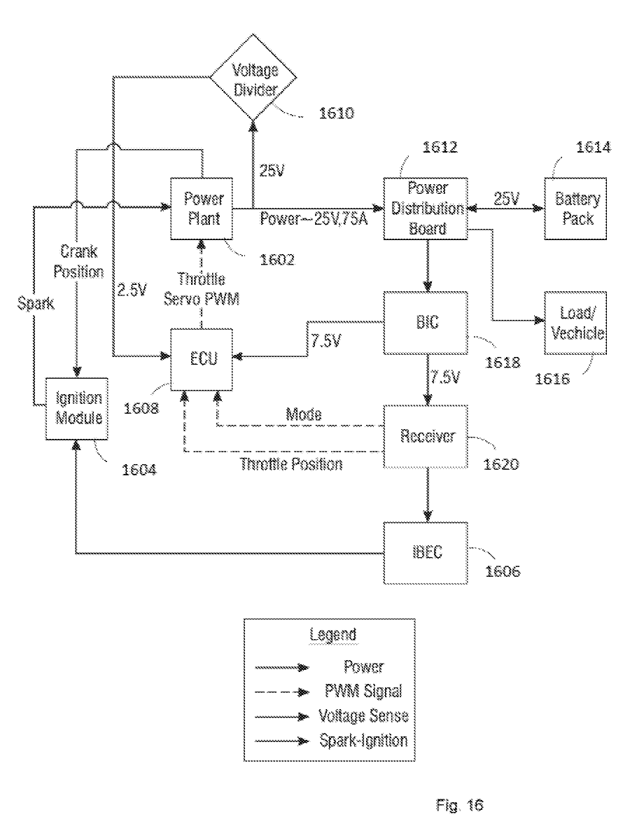

FIG. 16 shows a control system of a hybrid generator system. The hybrid generator system includes a power plant 1602 coupled to an ignition module 1604. The ignition module 1604 functions to start the power plant 1602 by providing a physical spark to the power plant 1604. The ignition module 1604 is coupled to an ignition battery eliminator circuit (IBEC) 1606. The IBEC 1606 functions to power the ignition module 1604.

The power plant 1602 is configured to provide power. The power plant 1602 includes an engine and a generator. The power plant is controlled by the ECU 1608. The ECU 1608 is coupled to the power plant through a throttle servo. The ECU 1608 can operate the throttle servo to control a throttle of an engine to cause the power plant 1602 to either increase or decrease an amount of produced power. The ECU 1608 is coupled to a voltage divider 1610. Through the voltage divider 1610, the ECU can determine an amount of power the ECU 1608 is generating to determine whether to increase, decrease, or keep a throttle of an engine constant.

The power plant is coupled to a power distribution board 1612. The power distribution board 1612 can distribute power generated by the power plant 1602 to either or both a battery pack 1614 and a load/vehicle 1616. The power distribution board 1612 is coupled to a battery eliminator circuit (BEC) 1618. The BEC 1618 provides power to the ECU 1608 and a receiver 1620. The receiver 1620 controls the IBEC 1606 and functions to cause the IBEC 1606 to power the ignition module 1604. The receiver 1620 also sends information to the ECU 1608 used in controlling a throttle of an engine of the power plant 1602. The receiver 1620 sends information to the ECU related to a throttle position of a throttle of an engine and a mode in which the hybrid generation system is operating.

FIG. 17 shows a top perspective view of a top portion 1700 of a drone powered through a hybrid generator system. The top portion 1700 of the drone shown in FIG. 13 includes six rotors 1702-1 through 1702-6 (hereinafter “rotors 1702”). The rotors 1702 are caused to spin by corresponding motors 1704-1 through 1704-6 (hereinafter “motors 1704”). The motors 1704 can be powered through a hybrid generator system. The top portion 1700 of a drone includes a top surface 1706. Edges of the top surface 1706 can be curved to reduce air drag and improve aerodynamic performance of the drone. The top surface includes an opening 1708 through which air can flow to aid in dissipating heat away from at least a portion of a hybrid generator system. In various embodiments, at least a portion of an air filter is exposed through the opening 1708.

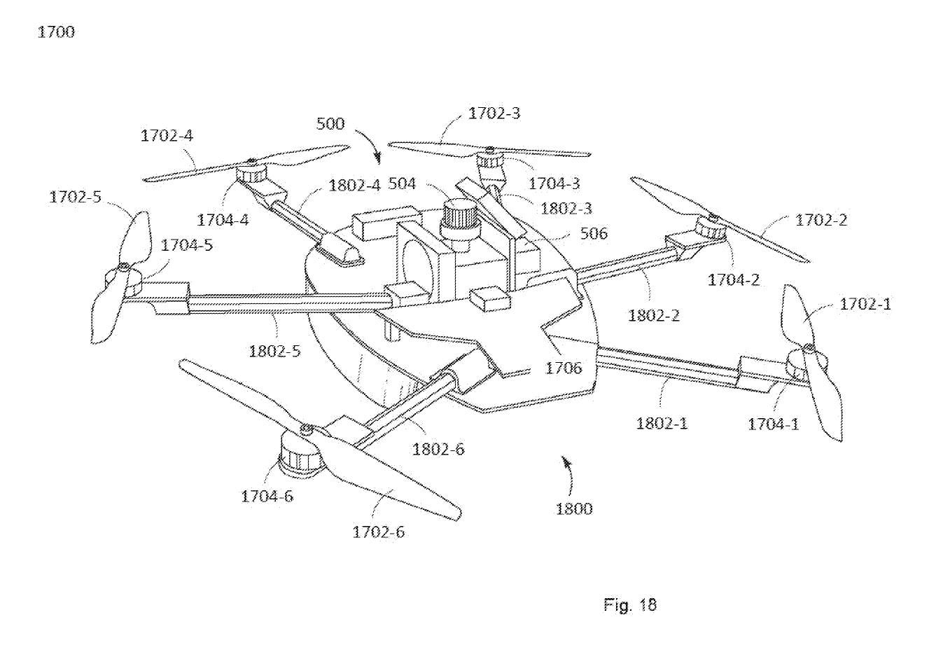

FIG. 18 shows a top perspective view of a bottom portion 1800 of a drone powered through a hybrid generator system 500. The hybrid generator system 500 includes an engine 504 and a generator motor 506 to provide power to motors 1704. The rotor motors 1704 and corresponding rotors 1702 are positioned away from a main body of a bottom portion 1800 of the drone through arms 1802-1 through 1802-6 (hereinafter “arms 1802”). An outer surface of the bottom portion of the bottom portion 1800 of the drone and/or the arms 1802 can have edges that are curved to reduce air drag and improve aerodynamic performance of the drone.

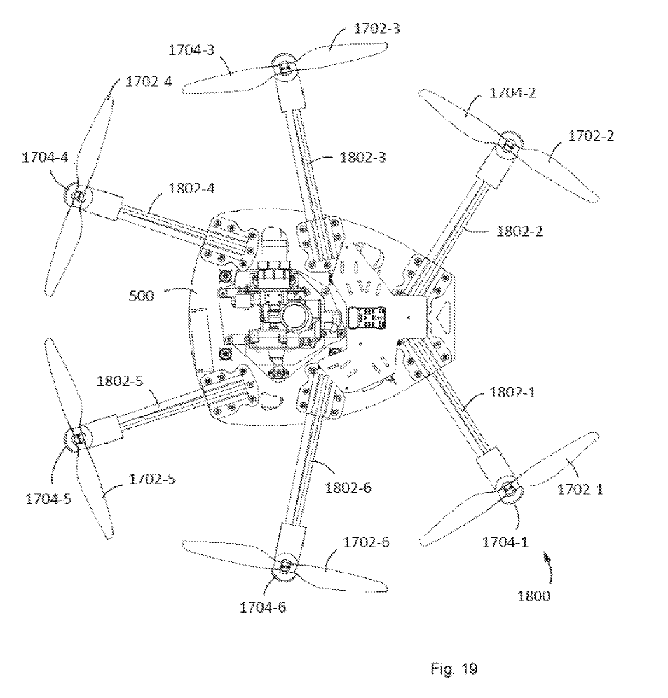

FIG. 19 shows a top view of a bottom portion 1800 of a drone powered through a hybrid generator system 500. The rotor motors 1704 and corresponding rotors 1702 are positioned away from a main body of a bottom portion 1800 of the drone through arms 1802. An outer surface of the bottom portion of the bottom portion 1800 of the drone and/or the arms 1802 can have edges that are curved to reduce air drag and improve aerodynamic performance of the drone.

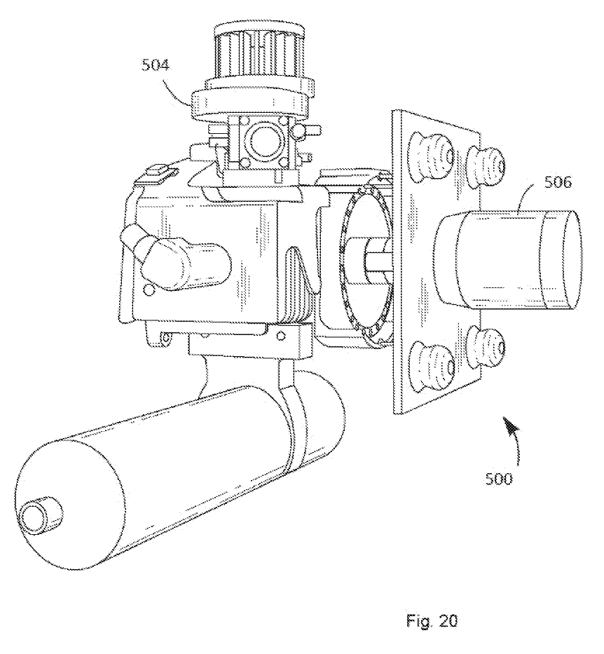

FIG. 20 shows a side perspective view of a hybrid generator system 500. The hybrid generator system 500 shown in FIG. 16 is capable of providing 1.8 kW of power. The hybrid generator system 500 include an engine 504 coupled to a generator motor 506. The engine 504 can provide approximately 3 horsepower. The generator motor 506 functions to generate AC output power using mechanical power generated by the engine 504.

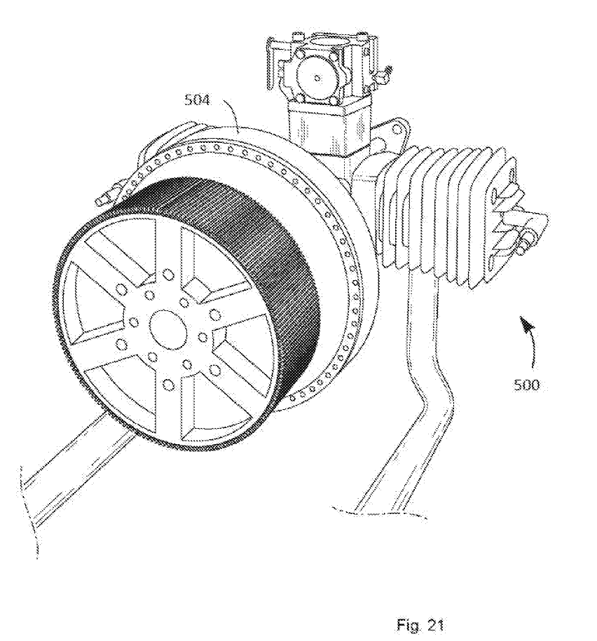

FIG. 21 shows a side perspective view of a hybrid generator system 500. The hybrid generator system 500 shown in FIG. 17 is capable of providing 10 kW of power. The hybrid generator system 500 include an engine 504 coupled to a generator motor. The engine 504 can provide approximately 15-16.5 horsepower. The generator motor functions to generate AC output power using mechanical power generated by the engine 504.

Further description of UAVs and hybrid generator systems can be found in U.S. application Ser. No. 14/942,600, filed on Nov. 16, 2015, the contents of which are incorporated here by reference in their entirety.

In some examples, the engine 504 can include features that enable the engine to operate with high power density. The engine 504 can be a two-stroke engine having a high power-to-weight ratio. The engine 504 can embody a simply design with a small number of moving parts such that the engine is small and light, thus contributing to the high power-to-weight ratio of the engine. In some examples, the engine may have an energy density of 1 kW/kg (kilowatt per kilogram) and generate about 10 kg of lift for every kilowatt of power generated by the engine. In some examples, the engine 504 can be a brushless motor, which can contribute to achieving a high power density of the engine. A brushless motor is efficient and reliable, and is generally not prone to sparking, thus reducing the risk of electromagnetic interference (EMI) from the engine.

In some examples, the engine 504 is mounted on the UAV via a vibration isolation system that enables sensitive components of the UAV to be isolated from vibrations generated by the engine. Sensitive components of the UAV can include, e.g., an inertial measurement unit such as Pixhawk, a compass, a global positioning system (GPS), or other components.

In some examples, the vibration isolation system can include vibration-damping mounts that attach the engine to the frame of the UAV. The vibration damping mounts allow for the engine 504 to oscillate independently from the frame of the UAV, thus preventing vibrations from being transmitted from the engine to other components of the UAV. The vibration damping mounts can be formed from a robust, energy absorbing material such as rubber, that can absorb the mechanical energy generated by the motion of the engine without tearing or ripping, thus preventing the mechanical energy from being transferred to the rest of the UAV. In some examples, the vibration damping mounts can be formed of two layers of rubber dampers joined together rigidly with a spacer. The length of the spacer can be adjusted to achieve a desired stiffness for the mount. The hardness of the rubber can be adjusted to achieve desired damping characteristics in order to absorb vibrational energy.

Referring to FIG. 22A, in some examples, the engine 504 and the generator motor 506 are directly coupled through a precise and robust connection (e.g., through a urethane coupling 704). In particular, the generator motor 506 includes a generator rotor 706 and a generator stator 708 housed in a generator body 2202. The generator rotor 706 is attached to the generator body 2202 by generator bearings 2204. The generator rotor 706 is coupled to an engine shaft 606 via the coupling 704. Precision coupling between the engine 504 and the generator motor 506 can be achieved by using precisely machined parts and balancing the weight and support of the rotating components of the generator motor 506, which in turn reduces internal stresses. Alignment of the generator rotor 706 with the engine shaft 606 can also help to achieve precision coupling. Misalignment between the rotor 706 and the engine shaft 606 can cause imbalances that can reduce efficiency and potentially lead to premature failure. In some examples, alignment of the rotor 706 with the engine shaft 606 can be achieved using precise indicators and fixtures. Precision coupling can be maintained by cooling the engine 504 and generator motor 506, by reducing external stresses, and by running the engine 504 and generator motor 506 under steady conditions, to the extent possible. For instance, the vibration isolation mounts allow external stresses on the engine 504 to be reduced or substantially eliminated, assisting in achieving precision direct coupling.

Direct coupling can contribute to the reliability of the first power system, which in turn enables the hybrid generator system to operate continuously for long periods of time at high power. In addition, direct coupling can contribute to the durability of the first power system, thus helping to reduce mechanical creep and fatigue even over many engine cycles (e.g., millions of engine cycles). In some examples, the engine is mechanically isolated from the frame of the UAV by the vibration isolation system and thus experiences minimal external forces, so the direct coupling between the engine and the generator motor can be implemented by taking into account only internal stresses.

Direct coupling between the engine 504 and the generator motor 506 can enable the first power system to be a compact, lightweight power system having a small form factor. A compact and lightweight power system can be readily integrated into the UAV.

Referring to FIG. 22B, in some examples, a frameless or bearing-less generator 608 can be used instead of a urethane coupling between the generator motor 506 and the engine 504. For instance, the bearings (2204 in FIG. 22A) on the generator can be removed and the generator rotor 706 can be directly mated to the engine shaft 606. The generator stator 708 can be fixed to a frame 610 of the engine 516. This configuration prevents over-constraining the generator with a coupling while providing a small form factor and reduced weight and complexity.

In some examples, the generator motor 506 includes a flywheel that provides a large rotational moment of inertia. A large rotational inertia can result in reduced torque spikes and smooth power output, thus reducing wear on the coupling between the engine 504 and the generator motor 506 and contributing to the reliability of the first power system. In some examples, the generator, when mated directly to the engine 504, acts as a flywheel. In some examples, the flywheel is a distinct component (e.g., if the generator does not provide enough rotary inertia).

In some examples, design criteria are set to provide good pairing between the engine 504 and the generator motor 506. The power band of a motor is typically limited to a small range. This power band can be used to identify an RPM (revolutions per minute) range within which to operate under most flight conditions. Based on the identified RPM range, a generator can be selected that has a motor constant (kV) that is able to provide the appropriate voltage for the propulsion system (e.g., the rotors). The selection of an appropriate generator helps to ensure that the voltage out of the generator will not drop as the load increases. For instance, if the engine has maximum power at 6500 RPM, and a 50 V system is desired for propulsion, then a generator can be selected that has a kV of 130.

In some examples, exhaust pipes can be designed to positively affect the efficiency of the engine 504. Exhaust pipes serve as an expansion chamber for exhaust from the engine, thus improving the volumetric efficiency of the engine. The shape of the exhaust pipes can be tuned to guide air back into the combustion chamber based on the resonance of the system. In some examples, the carburetor can also be tuned based on operating parameters of the engine, such as temperature or other parameters. For instance, the carburetor can be tuned to allow a desired amount of fuel into the engine, thus enabling a target fuel to air ratio to be reached in order to achieve a good combustion reaction in the engine. In addition, the throttle body can be designed to control fuel injection and/or timing in order to further improve engine output.

In some examples, the throttle of the engine can be regulated in order to achieve a desired engine performance. For instance, when the voltage of the system drops under a load, the throttle is increased; when the voltage of the system becomes too high, the throttle is decreased. The bus voltage can be regulated and a feedback control loop used to control the throttle position. In some examples, the current flow into the battery can be monitored with the goal of controlling the charge of the battery and the propulsion voltage. In some examples, feed forward controls can be provided such that the engine can anticipate upcoming changes in load (e.g., based on a mission plan and/or based on the load drawn by the motor) and preemptively compensates for the anticipated changes. Feed forward controls can enable the engine to respond to changes in load with less lag. In some examples, the engine can be controlled to charge the battery according to a pre-specified schedule, e.g., to maximize battery life, in anticipation of loads (e.g., loads forecast in a mission plan), or another goal. Throttle regulation can help keep the battery fully charged, helping to ensure that the system can run at a desired voltage and helping to ensure that backup power is available.

In some examples, ultra-capacitors can be incorporated into the hybrid generator system in order to allow the hybrid generator system to respond quickly to changing power demands. For instance, ultra-capacitors can be used in conjunction with one or more rechargeable batteries to provide a lightweight system capable of rapid response and smooth, reliable power.

In some examples, thermal management strategies can be employed in order to actively or passively cool components of the hybrid generator system. High power density components tend to overheat (e.g., because thermal dissipation is usually proportional to surface area). In addition, internal combustion is an inherently inefficient process, which creates heat.

Active cooling strategies can include fans, such as a centrifugal fan. The centrifugal fan can be coupled to the engine shaft so that the fan spins at the same RPM as the engine, thus producing significant airflow. The centrifugal fan can be positioned such that the airflow is directed over certain components of the engine (e.g., the hottest parts of the engine) such as the cylinder heads. Airflow generated by the flying motion of the UAV can also be used to cool the hybrid generator system. For instance, air pushed by the rotors of the UAV (referred to as prop wash) can be used to cool components of the hybrid generator system. Passive cooling strategies can be used alone or in combination with active cooling strategies in order to cool components of the hybrid generator system. In some examples, one or more components of the hybrid generator system can be positioned in contact with dissipative heat sinks, thus reducing the operating temperature of the components. For instance, the frame of the UAV can be formed of a thermally conductive material, such as aluminum, which can act as a heat sink. Referring to FIG. 22, in some examples, fins 2302 can be formed on the engine (e.g., on one or more of the cylinder heads of the engine) to increase the convective surface area of the engine, thus enabling increased heat transfer. In some examples, the hybrid generator system can be configured such that certain components are selectively exposed to ambient air or to airflow generated by the flying motion of the UAV in order to further cool the components.

In some examples, the materials of the hybrid generator system 500 and/or the UAV can be lightweight. For instance, materials with a high strength to weight ratio can be used to reduce weight. Example materials can include aluminum or high strength aluminum alloys (e.g., 7075 alloy), carbon fiber based materials, or other materials. Component design can also contribute to weight reduction. For instance, components can be designed to increase the stiffness and reduce the amount of material used for the components. In some examples, components can be designed such that material that is not relevant for the functioning of the component is removed, thus further reducing the weight of the component.

While the UAV has been largely described as being powered by a hybrid generator system that includes a gasoline-powered engine coupled to a generator motor, other types of power systems may also be used. In some implementations, the UAV may be powered at least in part by a turbine, such as a gasoline turbine. For example, a gasoline turbine can be used in place of the gasoline-powered engine. The gasoline turbine may be one of two separate power systems included as part of the hybrid generator system. That is, the hybrid generator system can include a first power system in the form of a gasoline turbine and a second power system in the form of a generator motor. The gasoline turbine may be coupled to the generator motor.

The gasoline turbine may provide higher RPM levels than those provided by a gasoline-powered engine (e.g., the engine 504 described above). Such higher RPM capability may allow a second power system (e.g., the generator motor 506 described above) to generate electricity (e.g., for charging the battery 510 described above) more quickly and efficiently.

The gasoline turbine, sometimes referred to as a combustion turbine, may include an upstream rotation compressor coupled to a downstream turbine with a combustion chamber there-between. The gasoline turbine may be configured to allow atmospheric air to flow through the compressor, thereby increasing the pressure of the air. Energy may then be added by applying (e.g., spraying) fuel, such as gasoline, into the air and igniting the fuel in order to generate a high-temperature flow. The high-temperature and high-pressure gas flow may then enter the turbine, where the gas flow can expand down to the exhaust pressure, thereby producing a shaft work output. The turbine shaft work is then used to drive the compressor and other devices, such as a generator (e.g., the generator motor 504) that may be coupled to the shaft. Energy that is not used for shaft work can be expelled as exhaust gases having one or both of a high temperature and a high velocity. One or more properties and/or dimensions of the gas turbine design can be chosen such that the most desirable energy form is maximized. In the case of use with a UAV, the gas turbine will typically be optimized to produce thrust from the exhaust gas or from ducted fans connected to the gas turbines.

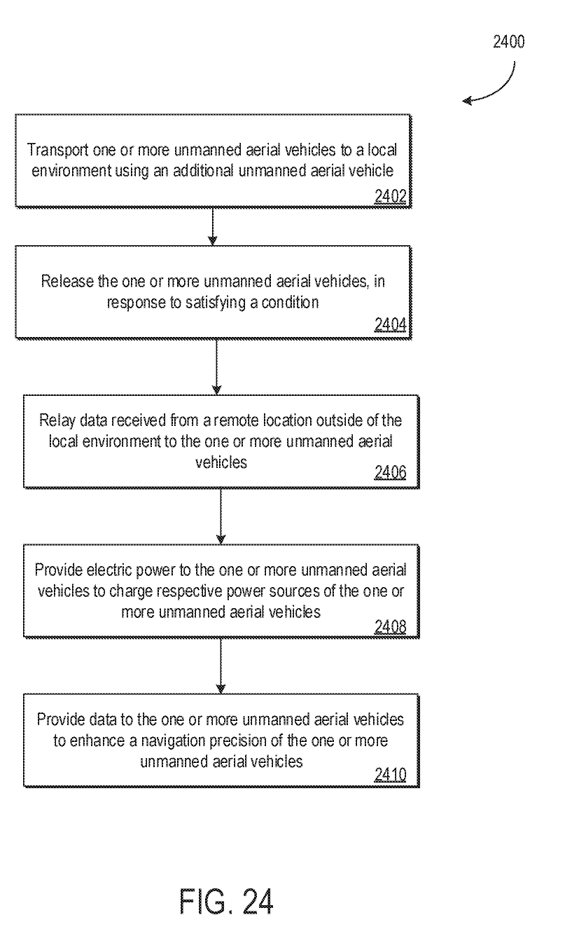

FIG. 24 shows an example process 2400 for transporting and deploying one or more remote devices (e.g., UAVs 120) by an unmanned aerial vehicle (e.g., portable launch platform 110 of FIG. 1).

The portable launch platform 110 is configured to release (2402) the one or more unmanned aerial vehicles, in response to satisfying a condition, into a local environment. The one or more unmanned aerial vehicles are configured to perform environmental measurements of the local environment. The portable launch platform 110 is configured to relay (2404) data received from a remote location outside of the local environment to the one or more unmanned aerial vehicles. In some implementations, the portable launch platform 110 is configured to other data received from the one or more unmanned aerial vehicles to the remote location outside of the local environment. The portable launch platform 110 is configured to provide (2406) electric power to the one or more unmanned aerial vehicles to charge respective power sources of the one or more unmanned aerial vehicles, such as after the one or more unmanned aerial vehicles have performed the environmental measurements in the local environment. The portable launch platform 110 is configured to provide (2408) data to the one or more unmanned aerial vehicles to enhance a navigation precision of the one or more unmanned aerial vehicles. In some implementations, the portable launch platform 110 is configured to provide a local real-time kinematic (RTK) position reference for the one or more unmanned aerial vehicles. In some implementations, the portable launch platform 110 is configured to relay global positioning system (GPS) data from a first unmanned aerial vehicle of the one or more unmanned aerial vehicles to a second unmanned aerial vehicle of the one or more unmanned aerial vehicles

A number of embodiments have been described. Nevertheless, it will be understood that various modifications may be made without departing from the spirit and scope of the subject matter described herein. Other such embodiments are within the scope of the following claims.

What is claimed is:

1. An unmanned aerial vehicle comprising:
a platform configured to transport a second unmanned aerial vehicle and release the second unmanned aerial vehicle in response to satisfying a condition;
a hybrid generator system comprising:
an engine configured to generate mechanical power; and
a generator motor coupled to the engine and configured to generate electrical power from the mechanical power generated by the engine; and
at least one rotor motor configured to drive at least one propeller to rotate, wherein the at least one rotor motor is powered by the electrical power generated by the generator motor.

2. The unmanned aerial vehicle of claim 1, wherein satisfying the condition comprises the platform being within a predetermined distance of a specified geographic location.

3. The unmanned aerial vehicle of claim 1, wherein satisfying the condition comprises the platform reaching a specified altitude.

4. The unmanned aerial vehicle of claim 1, wherein satisfying the condition comprises the platform receiving an instruction from a remote location.

5. The unmanned aerial vehicle of claim 1, wherein the electrical power is provided to the at least one rotor motor from the generator motor.

6. The unmanned aerial vehicle of claim 1, further comprising a rechargeable battery configured to store the electrical power generated by the generator motor.

7. The unmanned aerial vehicle of claim 6, wherein the electrical power is provided to the at least one rotor motor from the rechargeable battery.

8. The unmanned aerial vehicle of claim 1, further comprising:
a transceiver configured to wirelessly relay data from the second unmanned aerial vehicle to a remote location and wirelessly relay data from the remote location to the second unmanned aerial vehicle.

9. The unmanned aerial vehicle of claim 8, further comprising:
a microprocessor configured to process data received from the second unmanned aerial vehicle via the transceiver and send instructions to the unmanned vehicle via the transceiver in response to an analysis of the data received in real-time or near real-time.

10. The unmanned aerial vehicle of claim 1, wherein the platform comprises a capsule for transporting the second unmanned aerial vehicle.

11. The unmanned aerial vehicle of claim 1, wherein the platform is configured to transport one or more additional unmanned aerial vehicles and release the one or more additional unmanned aerial vehicles in response to an instruction.

12. The unmanned aerial vehicle of claim 11, wherein the one or more additional unmanned aerial vehicles and the second aerial vehicle form a mesh network.

13. The unmanned aerial vehicle of claim 1, wherein the second unmanned aerial vehicle includes an atmospheric sensor.

14. The unmanned aerial vehicle of claim 1, wherein the second unmanned aerial vehicle includes a beacon and a control.

15. The unmanned aerial vehicle of claim 1, wherein the second unmanned aerial vehicle is configured to map a topology of a local environment.

16. The unmanned aerial vehicle of claim 1, wherein the hybrid generator system is configured to provide electric power to the second unmanned aerial vehicle to charge a power source of the second unmanned aerial vehicle.

17. The unmanned aerial vehicle of claim 1, wherein the portable launch platform is configured to provide data to the second unmanned aerial vehicle to enhance a navigation precision of the second unmanned aerial vehicle.

18. The unmanned aerial vehicle of claim 17, wherein the portable launch platform provides a local real-time kinematic (RTK) position reference for the second unmanned aerial vehicle.

19. The unmanned aerial vehicle of claim 17, wherein the portable launch platform provides global positioning system (GPS) data from a remote device to the second unmanned aerial vehicle.

20. A method for performing environmental measurements, comprising:
transporting one or more unmanned aerial vehicles to a local environment using an additional unmanned aerial vehicle;
releasing, from the additional unmanned aerial vehicle, in response to satisfying a condition, the one or more unmanned aerial vehicles, wherein the one or more unmanned aerial vehicles are configured to perform environmental measurements of the local environment.

21. The method of claim 20, further comprising:
relaying, by the additional unmanned aerial vehicle, data received from a remote location outside of the local environment to the one or more unmanned aerial vehicles; and
relaying, by the additional unmanned aerial vehicle, other data received from the one or more unmanned aerial vehicles to the remote location outside of the local environment.

22. The method of claim 20, further comprising:
receiving, by the additional unmanned aerial vehicle, atmospheric measurements of the local environment from the one or more unmanned aerial vehicles.

23. The method of claim 20, further comprising:
providing, by the additional unmanned aerial vehicle, electric power to the one or more unmanned aerial vehicles to charge respective power sources of the one or more unmanned aerial vehicles after the one or more unmanned aerial vehicles have performed the environmental measurements in the local environment.

24. The method of claim 20, further comprising:
providing, by the additional unmanned aerial vehicle, data to the one or more unmanned aerial vehicles to enhance a navigation precision of the one or more unmanned aerial vehicles.

25. The method of claim 24, wherein the additional unmanned aerial vehicle provides a local real-time kinematic (RTK) position reference for the one or more unmanned aerial vehicles.

26. The method of claim 24, wherein the additional unmanned aerial vehicle relays global positioning system (GPS) data from a first unmanned aerial vehicle of the one or more unmanned aerial vehicles to a second unmanned aerial vehicle of the one or more unmanned aerial vehicles.
